(19) United States
(12) Patent Application Publication
(10) Pub. No.: US 2006/0163542 A1
(43) Pub. Date: Jul. 27, 2006

(54) Metal-complex compound and organic electroluminescence device using the compound

(75) Inventors: Ryusuke Watanabe, Chiba (JP); Fumio Okuda, Chiba (JP); Keiko Yamamichi, Chiba (JP); Toshihiro Iwakuma, Chiba (JP); Seiji Tomita, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Idemitsu Kosan Co., Ltd., Tokyo (JP)

(21) Appl. No.: 11/295,600

(22) Filed: Dec. 7, 2005

Related U.S. Application Data
(63) Continuation of application No. PCT/JP05/16659, filed on Sep. 9, 2005.

(30) Foreign Application Priority Data
Sep. 10, 2004 (JP) 2004-263536

(51) Int. Cl. H01B 1/12

(52) U.S. Cl. 252/500

(57) ABSTRACT

A metal-complex compound having a special structure containing metals such as iridium. An organic electroluminescence device which comprises at least one organic thin film layer sandwiched between a pair of electrodes, wherein the organic thin film layer comprises the metal-complex compound. The organic electroluminescence device employing the metal-complex compound exhibits an enhanced current efficiency and prolonged lifetime.

### TECHNICAL FIELD

The present invention relates to a novel metal-complex compound and an organic electroluminescence device using the compound. Particularly, the present invention relates to an organic electroluminescence device which emits blue light with high purity and of short wavelength, and to a metal-complex compound realizing it.

### BACKGROUND ART

An organic electroluminescence (“electroluminescence” will be referred to as “EL”, hereinafter) device is a spontaneous light emitting device which utilizes the principle that a fluorescent substance emits light by energy of recombination of holes injected from an anode and electrons injected from a cathode when an electric field is applied. Since an organic EL device of the laminate type driven under a low electric voltage was reported by C. W. Tang et al. of Eastman Kodak Company (C. W. Tang and S. A. Vanslyke, Applied Physics Letters, Volume 51, Pages 913, 1987), many studies have been conducted on organic EL devices using organic materials as the constituting materials. Tang et al. used a laminate structure using tris(8-hydroxyquinolinol aluminum) for the light emitting layer and a triphenyldiamine derivative for the hole transporting layer. Advantages of the laminate structure are that the efficiency of hole injection into the light emitting layer can be increased, that the efficiency of forming excited particles which are formed by blocking and recombining electrons injected from the cathode can be increased, and that excited particles formed among the light emitting layer can be enclosed. As the structure of the organic EL device, a two-layered structure having a hole transporting (injecting) layer and an electron transporting and light emitting layer and a three-layered structure having a hole transporting (injecting) layer, a light emitting layer and an electron transporting (injecting) layer are well known. To increase the efficiency of recombination of injected holes and electrons in the devices of the laminate type, the structure of the device and the process for forming the device have been studied.

As the light emitting material of the organic EL device, chelate complexes such as tris(8-quinolinolato)aluminum, coumarine derivatives, tetraphenylbutadiene derivatives, bisstyrylarylene derivatives and oxadiazole derivatives are known. It is reported that light in the visible region ranging from blue light to red light can be obtained by using these light emitting materials, and development of a device exhibiting color images is expected (Refer to, for example, Patent Literatures 1, 2 and 3 below).

Further, in late years, employing of a phosphorescent material other than the luminescent material as the light emitting layer of the organic EL device is proposed. (Refer to, for example, Non-patent Literatures 1 and 2 below.) As described above, a great efficiency of light emission is achieved by utilizing an organic phosphorescent material excited to the singlet state and the triplet state in the light emitting layer of an organic EL device. It is considered that singlet excimers and triplet excimers are formed in relative amounts of 1:3 due to the difference in the multiplicity of spin when electrons and holes are recombined in an organic EL device. Therefore, it is expected that an efficiency of light emission 3 to 4 times as great as that of a device utilizing fluorescence alone can be achieved by utilizing a phosphorescent light emitting material.

In the organic EL devices such as those described above, constructions in which layers such as an anode, an organic light emitting layer, an electron transporting layer (a hole barrier layer), an electron injecting layer and a cathode are successively laminated are used so that light emission in the condition excited to the triplet state or from excimers in the triplet state is not quenched. In the organic light emitting layer, a host compound and the phosphorescent light emitting compound are employed. (Refer to, for example, Patent Literatures 4 and 5 below.) Those Patent Literatures relate to the phosphorescent light emitting materials emitting red-to-green light. Further, technology about a bluish light emitting material is also published in a few documents. (Refer to, for example, Patent Literatures 6 to 8 below.) However, the material provides very short lifetime of the EL device. In particular, Patent Literatures 7 and 8 below disclose a ligand skeleton in which Ir metal and a phosphorus atom bond each other, and although a color of light emission varies to blue, heat resistance is furiously poor because the bonding is weak. Furthermore, although Patent Literature 9 below discloses about a complex in which an oxygen atom and a nitrogen atom bond to a central metal similarly, there is no description about specific effect of a group that bonds to the oxygen atom, which is indistinct. Moreover, Patent Literature 10 below discloses a complex in which a nitrogen atom contained in different ring structures bonds to a central metal one by one, and although an organic EL device employing the complex exhibits blue light emission, an external quantum efficiency of the device is as low as around 5%.
Patent Literature 1: Japanese Patent Application Laid-Open No. Heisei 8(1996)-239655
Patent Literature 2: Japanese Patent Application Laid-Open No. Heisei 7(1995)-183561
Patent Literature 3: Japanese Patent Application Laid-Open No. Heisei 3(1991)-200289.
Patent Literature 4: U.S. Pat. No. 6,097,147
Patent Literature 5: International PCT Publication No. WO 01/41512
Patent Literature 6: U.S. Patent Application Publication No. US 2001/0025108
Patent Literature 7: U.S. Patent Application Publication No. US 2002/0182441
Patent Literature 8: Japanese Patent Application Laid-Open No. 2002-170684
Patent Literature 9: Japanese Patent Application Laid-Open No. 2003-123982
Patent Literature 10: Japanese Patent Application Laid-Open No. 2003-133074
Non-patent Literature 1: D. F. O'Brien and M. A. Baldo et al “Improved energy transfer in electrophosphorescent devices” Applied Physics letters Vol. 74 No. 3, pp 442-444, Jan. 18, 1999
Non-patent Literature 2: M. A. Baldo et al “Very high-efficiency green organic light-emitting devices based on electrophosphorescence” Applied Physics letters Vol. 75 No. 1, pp 4-6, Jul. 5, 1999

### DISCLOSURE OF THE INVENTION

The present invention has been made to overcome the above problems and has an object of providing an organic EL device having prolonged lifetime with an enhanced efficiency of light emission, and an object of providing a novel metal-complex compound realizing it.

As a result of intensive researches and studies to achieve the above object by the present inventors, it was found that an employment of a metal-complex compound represented by a following general formula (1) provides the EL device having an enhanced efficiency of light emission and prolonged lifetime, resultantly completing the present invention.

Namely, the present invention provides a metal-complex compound represented by a following general formula (1):
(L₁)ₘM(L₂)ₙ (1)
wherein M represents a metal atom of iridium (Ir), platina (Pt), rhodium (Rh), ruthenium (Ru) or palladium (Pd); L₁ and L₂ each independently represent a bidentate ligand that is different from each other;
a partial structure (L₁)ₘM is expressed by a following general formula (2);
a partial structure M(L₂)ₙ is expressed by a following general formula (3);
m and n each independently represents an integer of 1 or 2, while m plus n makes an integer of 2 or 3.

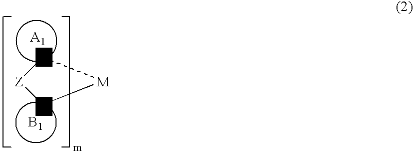

In the general formula (2), N and C each respectively corresponds to a nitrogen atom and a carbon atom in this order;

A1 ring corresponds to an aromatic heterocyclic group containing a nitrogen atom and having 3 to 50 nuclear carbon atoms which may have a substituent;

B1 ring corresponds to an aryl group having 6 to 50 nuclear carbon atoms which may have a substituent;

A1 ring and B1 ring bonds each other with a covalent bond that shares Z; and Z represents a single bond, —O—, —S—, —CO—, —(CR′R″)ₐ—, —(SiR′R″)ₐ— or —NR′—.

R′ and R″ each independently represents a hydrogen atom, an aryl group having 6 to 50 nuclear carbon atoms which may have a substituent, an aromatic heterocyclic group having 3 to 50 nuclear atoms which may have a substituent, or an alkyl group having 1 to 50 carbon atoms which may have a substituent; and a represents an integer of 1 to 10, while R′s and R″s may be the same with or different from each other.

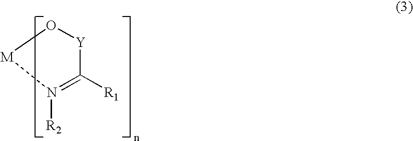

In the general formula (3), N and O each respectively corresponds to a nitrogen atom and an oxygen atom in this order;

R₁ and R₂ each independently represents an alkyl group having 1 to 50 carbon atoms which may have a substituent, an alkenyl group having 2 to 50 carbon atoms which may have a substituent, or an aryl group having 6 to 50 nuclear carbon atoms which may have a substituent; while R₁ and R₂ may bond each other to form a ring structure.

In the general formula (3), Y represents any one of following groups: 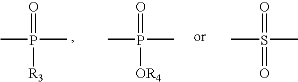
wherein P and S each corresponds to a phosphorus atom and a sulfur atom in this order; R₃ and R₄ each independently represents an alkyl group having 1 to 50 carbon atoms which may have a substituent, or an aryl group having 6 to 50 nuclear carbon atoms which may have a substituent.

Further, the present invention provides an organic EL device which comprises at least one organic thin film layer sandwiched between a pair of electrodes consisting of an anode and a cathode, wherein the organic thin film layer comprises the metal-complex compound.

The present invention provides an organic EL device with an enhanced efficiency of light emission and with a prolonged lifetime.

### PREFERRED EMBODIMENTS TO CARRY OUT THE INVENTION

The present invention provides a metal-complex compound represented by a following general formula (1):
(L₁)ₘM(L₂)ₙ (1)

In the general formula (1), M represents a metal atom of iridium (Ir), platinum (Pt), rhodium (Rh), ruthenium (Ru) or palladium (Pd).

In the general formula (1), L₁ and L₂ each independently represents a bidentate ligand that is different from each other;

a partial structure (L₁)ₘM is expressed by a following general formula (2);

a partial structure M(L₂)ₙ is expressed by a following general formula (3);

In the general formulae (1) to (3), m and n each independently represents an integer of 1 or 2, while m plus n makes an integer of 2 or 3.

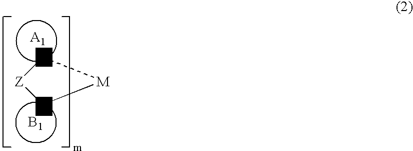

In the general formula (2), N and C each respectively corresponds to a nitrogen atom and a carbon atom in this order.

In the general formula (2), A1 ring corresponds to an aromatic heterocyclic group containing a nitrogen atom and having 3 to 50 nuclear carbon atoms which may have a substituent; B1 ring corresponds to an aryl group having 6 to 50 nuclear carbon atoms which may have a substituent; while A1 ring and B1 ring bonds each other with a covalent bond that shares Z.

With regard to the aromatic heterocyclic group as the A1 ring, it is preferable to have 3 to 20 nuclear carbon atoms, and it is more preferable to have 3 to 10 nuclear carbon atoms. Example of the aromatic heterocyclic group include pyrrolyl group, pyrazinyl group, pyridinyl group, imidazolyl group, pyrazolyl group, indolizinyl group, imidazopyridinyl group, quinolyl group, isoquinolyl group, quinoxalinyl group, β-carbonylyl group, phenanthridinyl group, 1,7-phenanthrolinyl group, 1,8-phenanthrolinyl group, 1,9-phenanthrolinyl group, 1,10-phenanthrolinyl group, 2,9-phenanthrolinyl group, 2,8-phenanthrolinyl group, 2,7-phenanthrolinyl group, etc.

Among those, pyridinyl group, imidazopyridinyl group, pyrazolyl group and pyrazinyl group are preferable.

With regard to the aryl group as the B1 ring, it is preferable to have 6 to 40 nuclear carbon atoms, and it is more preferable to have 6 to 24 nuclear carbon atoms. Examples of the aryl group include phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, a 1-naphthacenyl group, 2-naphthacenyl group, 9-naphthacenyl group, 1-pyrenyl group, 2-pyrenyl group, 4-pyrenyl group, 2-biphenylyl group, 3-biphenylyl group, 4-biphenylyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenyl-yl group, 4″-t-butyl-p-terphenyl-4-yl group, o-cumenyl group, m-cumenyl group, p-cumenyl group, 2,3-xylyl group, 3,4-xylyl group, 2,5-xylyl group, mesityl group, etc.

Among those, phenyl group, 1-naphthyl group, 2-naphthyl group, 9-phenanthryl group, 2-biphenylyl group, 3-biphenylyl group, 4-biphenylyl group, p-tolyl group and 3,4-xylyl group are preferable.

In the general formula (1), Z represents a single bond, —O—, —S—, —CO—, —(CR′R″)ₐ—, —(SiR′R″)ₐ— or —NR′—;

R′ and R″ each independently represents a hydrogen atom, an aryl group having 6 to 50 nuclear carbon atoms which may have a substituent, an aromatic heterocyclic group having 3 to 50 nuclear atoms which may have a substituent, or an alkyl group having 1 to 50 carbon atoms which may have a substituent; and a represents an integer of 1 to 10, while R′s and R″s may be the same with or different from each other.

Examples of the aryl group represented by R′ or R″ include the same groups explained about the above B1 ring, examples of the aromatic heterocyclic group represented by R′ or R″ include the same groups explained about the above A1 ring, and examples of the alkyl group represented by R′ or R″ include the same groups as will be explained about a following general formula (3) below.

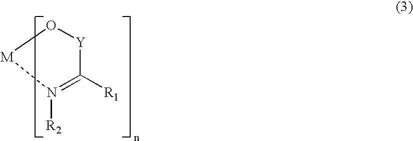

In the general formula (3), N and O each respectively corresponds to a nitrogen atom and an oxygen atom in this order.

In the general formula (3), R₁ and R₂ each independently represents an alkyl group having 1 to 50 carbon atoms which may have a substituent, an alkenyl group having 2 to 50 carbon atoms which may have a substituent, or an aryl group having 6 to 50 nuclear carbon atoms which may have a substituent; while R₁ and R₂ may bond each other to form a ring structure.

With regard to the alkyl group represented by R₁ or R₂, it is preferable to have 1 to 30 carbon atoms, and it is more preferable to have 1 to 10 carbon atoms. Examples of the alkyl group include methyl group, ethyl group, propyl group, isopropyl group, n-butyl group, s-butyl group, isobutyl group, t-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, neopentyl group, 1-methyl pentyl group, 2-methyl pentyl group, 1-pentyl hexyl group, 1-butylpentyl group, 1-heptyl octyl group, 3-methylpentyl group, hydroxymethyl group, 1-hydroxyethyl group, 2-hydroxyethyl group, 2-hydroxy isobutyl group, 1,2-dihydroxy ethyl group, 1,3-dihydroxy isopropyl group, 2,3-dihydroxy-t-butyl group, 1,2,3-trihydroxy propyl group, chloromethyl group, 1-chloroethyl group, 2-chloroethyl group, 2-chloro isobutyl group, 1,2-dichloroethyl group, 1,3-dichloro isopropyl group, 2,3-dichloro-t-butyl group, 1,2,3-trichloro propyl group, bromomethyl group, 1-bromoethyl group, 2-bromoethyl group, 2-bromo isobutyl group, 1,2-dibromo ethyl group, 1,3-dibromo isopropyl group, 2,3-dibromo-t-butyl group, 1,2,3-tribromo propyl group, iodo methyl group, 1-iodo ethyl group, 2-iodo ethyl group, 2-iodo isobutyl group, 1,2-diiodo ethyl group, 1,3-diiodo isopropyl group, 2,3-diiodo-t-butyl group, 1,2,3-triiodo propyl group, an aminomethyl group, 1-amino ethyl group, 2-amino ethyl group, 2-amino isobutyl group, 1,2-diamino ethyl group, 1,3-diamino isopropyl group, 2,3-diamino-t-butyl group, 1,2,3-triaminopropyl group, cyanomethyl group, 1-cyanoethyl group, 2-cyanoethyl group, 2-cyano isobutyl group, 1,2-dicyano ethyl group, 1,3-dicyano isopropyl group, 2,3-dicyano-t-butyl group, 1,2,3-tricyanopropyl group, nitromethyl group, 1-nitroethyl group, 2-nitroethyl group, 1,2-dinitro ethyl group, 2,3-dinitro-t-butyl group, 1,2,3-trinitro propyl group, cyclopentyl group, cyclohexyl group, cyclo octyl group, 3,5-tetramethylcyclohexyl group, etc.

Among those, methyl group, ethyl group, propyl group, isopropyl group, n-butyl group, s-butyl group, isobutyl group, t-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, neopentyl group, 1-methyl pentyl group, 1-pentylhexyl group, 1-butylpentyl group, 1-heptyl octyl group, cyclohexyl group, cyclo octyl group and 3,5-tetramethyl cyclohexyl group are preferable.

With regard to the alkenyl group represented by R₁ or R₂, it is preferable to have 2 to 30 carbon atoms, and it is more preferable to have 2 to 16 carbon atoms. Examples of the alkenyl group include vinyl group, aryl group, 1-butenyl group, 2-butenyl group, 3-butenyl group, 1,3-butanedienyl group, 1-methylvinyl group, styryl group, 2,2-diphenylvinyl group, 1,2-diphenylvinyl group, 1-methylallyl group, 1,1-dimethylaryl group, 2-methylaryl group, 1-phenylaryl group, 2-phenylaryl group, 3-phenylaryl group, 3,3-diphenylaryl group, 1,2-dimethylaryl group, 1-phenyl-1-butenyl group, 3-phenyl-1-butenyl group, etc. Among those, styryl group, 2,2-diphenylvinyl group and 1,2-diphenylvinyl group are preferable.

With regard to the aryl group represented by R₁ or R₂, the same examples as explained about the foregoing B1 ring are employable. In the general formula (3), Y represents any one of following groups: 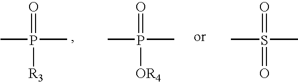
wherein P and S each corresponds to a phosphorus atom and a sulfur atom in this order; R₃ and R₄ each independently represents an alkyl group having 1 to 50 carbon atoms which may have a substituent, or an aryl group having 6 to 50 nuclear carbon atoms which may have a substituent.

With regard to the alkyl group and the aryl group represented by R₃ or R₄, the same examples as explained about the foregoing groups represented by R₁ and R₂ are employable.

In the general formula (1), it is preferable that the partial structure (L₁)ₘM expressed by the general formula (2) is represented by a following general formula (4) or a following general formula (5): 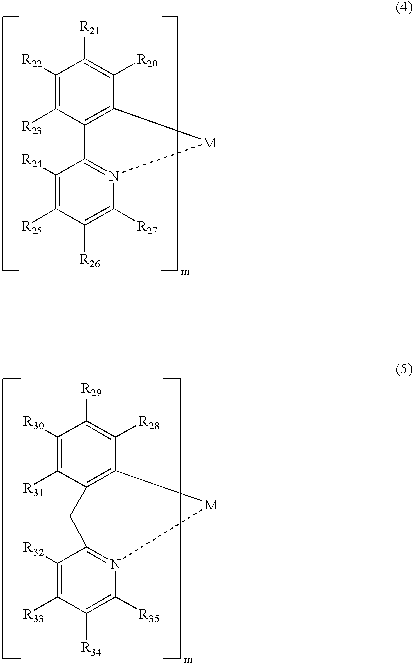
wherein M and m are the same as the foregoing description; R₂₀ to R₃₅ each independently represents a hydrogen atom, an alkyl group having 1 to 30 carbon atoms which may have a substituent, an alkyl halide group having 1 to 30 carbon atoms which may have a substituent, an alkoxy group having 1 to 30 carbon atoms which may have a substituent, a heterocyclic group having 3 to 20 nuclear carbon atoms which may have a substituent, an aryl group having 6 to 40 nuclear carbon atoms which may have a substituent, an aryloxy group having 6 to 40 nuclear carbon atoms which may have a substituent, an aralkyl group having 7 to 40 carbon atoms which may have a substituent, an alkenyl group having 2 to 30 carbon atoms which may have a substituent, an arylamino group having 6 to 80 nuclear carbon atoms which may have a substituent, an alkylamino group having 1 to 60 carbon atoms which may have a substituent, an aralkylamino group having 7 to 80 carbon atoms which may have a substituent, an alkylsilyl group having 1 to 30 carbon atoms which may have a substituent, an arylsilyl group having 6 to 40 carbon atoms which may have a substituent, a halogen atom, a cyano group, a nitro group, —S(R)O₂ or —S(R)O, wherein R represents a substituent; and wherein each adjacent couple among R₂₀ to R₂₇ and R₂₈ to R₃₅ may bond each other to form a ring structure.

In the general formula (1), it is preferable that the partial structure M(L₂)ₙ expressed by the general formula (3) is represented by any one of following general formulae (6) to (10): 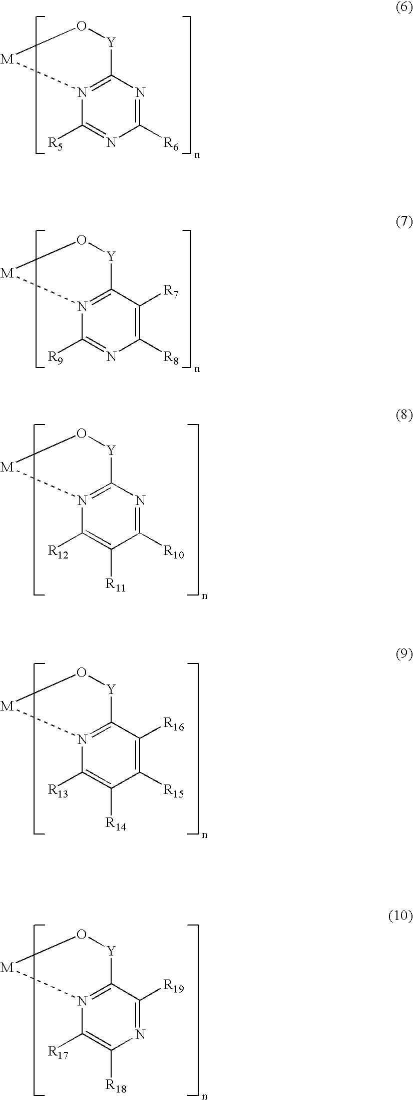
wherein M, Y and n are the same as the foregoing description; R₅ to R₁₉ each independently represents the same as the above description about R₂₀ to R₃₅; a couple of R₇ and R₈, a couple of R₁₀ and R₁₁, a couple of R₁₁ and R₁₂, a couple of R₁₃ and R₁₄, a couple of R₁₄ and R₁₅, a couple of R₁₅ and R₁₆, and a couple of R₁₇ and R₁₈ may bond each other to form a ring structure.

It is preferable for the alkyl group having 1 to 30 carbon atoms which may have a substituent represented by R₅ to R₃₅ to have 1 to 10 carbon atoms. Examples of the alkyl group include methyl group, ethyl group, propyl group, isopropyl group, n-butyl group, s-butyl group, isobutyl group, t-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, neopentyl group, 1-methylpentyl group, 2-methylpentyl group, 1-pentylhexyl group, 1-butylpentyl group, 1-heptyl octyl group, 3-methylpentyl group, hydroxymethyl group, 1-hydroxyethyl group, 2-hydroxyethyl group, 2-hydroxy isobutyl group, 1,2-dihydroxy ethyl group, 1,3-dihydroxy isopropyl group, 2,3-dihydroxy-t-butyl group, 1,2,3-trihydroxy propyl group, aminomethyl group, 1-amino ethyl group, 2-amino ethyl group, 2-amino isobutyl group, 1,2-diamino ethyl group, 1,3-diamino isopropyl group, 2,3-diamino-t-butyl group, 1,2,3-triamino propyl group, cyanomethyl group, 1-cyanoethyl group, 2-cyanoethyl group, 2-cyano isobutyl group, 1,2-dicyano ethyl group, 1,3-dicyano isopropyl group, 2,3-dicyano-t-butyl group, 1,2,3-tricyano propyl group, nitromethyl group, 1-nitroethyl group, 2-nitroethyl group, 1,2-dinitro ethyl group, 2,3-dinitro-t-butyl group, 1,2,3-trinitropropyl group, cyclopentyl group, cyclohexyl group, cyclo octyl group, 3,5-tetramethylcyclohexyl group, etc.

Among those, methyl group, ethyl group, propyl group, isopropyl group, n-butyl group, s-butyl group, isobutyl group, t-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, neopentyl group, 1-methylpentyl group, 1-pentylhexyl group, 1-butylpentyl group, 1-heptyloctyl group, cyclohexyl group, cyclo octyl group, 3,5-tetramethylcyclohexyl group are preferable.

It is preferable for the alkyl halide group having 1 to 30 carbon atoms which may have a substituent represented by R₅ to R₃₅ to have 1 to 10 carbon atoms. Examples of the alkyl halide group include chloromethyl group, 1-chloroethyl group, 2-chloroethyl group, 2-chloro isobutyl group, 1,2-dichloroethyl group, 1,3-dichloro isopropyl group, 2,3-dichloro-t-butyl group, 1,2,3-trichloro propyl group, bromomethyl group, 1-bromoethyl group, 2-bromoethyl group, 2-bromo isobutyl group, 1,2-dibromoethyl group, 1,3-dibromo isopropyl group, 2,3-dibromo-t-butyl group, 1,2,3-tribromo propyl group, iodomethyl group, 1-iodo ethyl group, 2-iodo ethyl group, 2-iodo isobutyl group, 1,2-diiodo ethyl group, 1,3-diiodo isopropyl group, 2,3-diiodo-t-butyl group, 1,2,3-triiodo propyl group, fluoromethyl group, 1-fluoromethyl group, 2-fluoromethyl group, 2-fluoro isobutyl group, 1,2-difluoro ethyl group, difluoromethyl group, trifluoromethyl group, pentafluoro ethyl group, perfluoro isopropyl group, perfluorobutyl group, perfluorocyclohexyl group, etc.

Among those, fluoromethyl group, trifluoromethyl group, pentafluoro ethyl group, perfluoro isopropyl group, perfluorobutyl group and perfluorocyclohexyl group are preferable.

The alkoxy group having 1 to 30 carbon atoms which may have a substituent represented by R₅ to R₃₅ is a group expressed by —OY₁; and examples of the Y₁ are the same as those explained about the foregoing alkyl group and the foregoing alkyl halide group.

With regard to the heterocyclic group having 3 to 20 nuclear carbon atoms which may have a substituent represented by the R₅ to R₃₅, it is preferable to have 3 to 10 nuclear carbon atoms. Examples of the heterocyclic groups include 1-pyrrolyl group, 2-pyrrolyl group, 3-pyrrolyl group, pyrazinyl group, 2-pyridinyl group, 1-imidazolyl group, 2-imidazolyl group, 1-pyrazolyl group, 1-indolizinyl group, 2-indolizinyl group, 3-indolizinyl group, 5-indolizinyl group, 6-indolizinyl group, 7-indolizinyl group, 8-indolizinyl group, 2-imidazopyridinyl group, 3-imidazopyridinyl group, 5-imidazopyridinyl group, 6-imidazopyridinyl group, 7-imidazopyridinyl group, 8-imidazopyridinyl group, 3-pyridinyl group, 4-pyridinyl group, 1-indolyl group, 2-indolyl group, 3-indolyl group, 4-indolyl group, 5-indolyl group, 6-indolyl group, 7-indolyl group, 1-iso indolyl group, 2-iso indolyl group, 3-iso indolyl group, 4-iso indolyl group, 5-iso indolyl group, 6-iso indolyl group, 7-iso indolyl group, 2-furyl group, 3-furyl group, 2-benzofuranyl group, 3-benzofuranyl group, 4-benzofuranyl group, 5-benzofuranyl group, 6-benzofuranyl group, 7-benzofuranyl group, 1-isobenzofuranyl group, 3-isobenzofuranyl group, 4-isobenzofuranyl group, 5-isobenzofuranyl group, 6-isobenzofuranyl group, 7-isobenzofuranyl group, 2-quinolyl group, 3-quinolyl group, 4-quinolyl group, 5-quinolyl group, 6-quinolyl group, 7-quinolyl group, 8-quinolyl group, 1-isoquinolyl group, 3-isoquinolyl group, 4-isoquinolyl group, 5-isoquinolyl group, 6-isoquinolyl group, 7-isoquinolyl group, 8-isoquinolyl group, 2-quinoxalinyl group, 5-quinoxalinyl group, 6-quinoxalinyl group, 1-carbazolyl group, 2-carbazolyl group, 3-carbazolyl group, 4-carbazolyl group, 9-carbazolyl group, β-carboline-1-yl group, β-carboline-2-yl group, β-carboline-3-yl group, β-carboline-4-yl group, β-carboline-5-yl group, β-carboline-6-yl group, β-carboline-7-yl group, β-carboline-8-yl group, β-carboline-9-yl group, 1-phenanthridinyl group, 2-phenanthridinyl group, 3-phenanthridinyl group, 4-phenanthridinyl group, 6-phenanthridinyl group, 7-phenanthridinyl group, 8-phenanthridinyl group, 9-phenanthridinyl group, 10-phenanthridinyl group, 1-acridinyl group, 2-acridinyl group, 3-acridinyl group, 4-acridinyl group, 9-acridinyl group, 1,7-phenanthroline-2-yl group, 1,7-phenanthroline-3-yl group, 1,7-phenanthroline-4-yl group, 1,7-phenanthroline-5-yl group, 1,7-phenanthroline-6-yl group, 1,7-phenanthroline-8-yl group, 1,7-phenanthroline-9-yl group, 1,7-phenanthroline-10-yl group, 1,8-phenanthroline-2-yl group, 1,8-phenanthroline-3-yl group, 1,8-phenanthroline-4-yl group, 1,8-phenanthroline-5-yl group, 1,8-phenanthroline-6-yl group, 1,8-phenanthroline-7-yl group, 1,8-phenanthroline-9-yl group, 1,8-phenanthroline-10-yl group, 1,9-phenanthroline-2-yl group, 1,9-phenanthroline-3-yl group, 1,9-phenanthroline-4-yl group, 1,9-phenanthroline-5-yl group, 1,9-phenanthroline-6-yl group, 1,9-phenanthroline-7-yl group, 1,9-phenanthroline-8-yl group, 1,9-phenanthroline-10-yl group, 1,10-phenanthroline-2-yl group, 1,10-phenanthroline-3-yl group, 1,10-phenanthroline-4-yl group, 1,10-phenanthroline-5-yl group, 2,9-phenanthroline-1-yl group, 2,9-phenanthroline-3-yl group, 2,9-phenanthroline-4-yl group, 2,9-phenanthroline-5-yl group, 2,9-phenanthroline-6-yl group, 2,9-phenanthroline-7-yl group, 2,9-phenanthroline-8-yl group, 2,9-phenanthroline-10-yl group, 2,8-phenanthroline-1-yl group, 2,8-phenanthroline-3-yl group, 2,8-phenanthroline-4-yl group, 2,8-phenanthroline-5-yl group, 2,8-phenanthroline-6-yl group, 2,8-phenanthroline-7-yl group, 2,8-phenanthroline-9-yl group, 2,8-phenanthroline-10-yl group, 2,7-phenanthroline-1-yl group, 2,7-phenanthroline-3-yl group, 2,7-phenanthroline-4-yl group, 2,7-phenanthroline-5-yl group, 2,7-phenanthroline-6-yl group, 2,7-phenanthroline-8-yl group, 2,7-phenanthroline-9-yl group, 2,7-phenanthroline-10-yl group, 1-phenazinyl group, 2-phenazinyl group, 1-phenothiazinyl group, 2-phenothiazinyl group, 3-phenothiazinyl group, 4-phenothiazinyl group, 10-phenothiazinyl group, 3-phenoxazinyl group, 2-phenoxazinyl group, 3-phenoxazinyl group, 4-phenoxazinyl group, 10-phenoxazinyl group, 2-oxazolyl group, 4-oxazolyl group, 5-oxazolyl group, 2-oxadiazolyl group, 5-oxadiazolyl group, 3-furazanyl group, 2-thienyl group, 3-thienyl group, 2-methylpyrrole-1-yl group, 2-methylpyrrole-3-yl group, 2-methylpyrrole-4-yl group, 2-methylpyrrole-5-yl group, 3-methylpyrrole-1-yl group, 3-methylpyrrole-2-yl group, 3-methylpyrrole-4-yl group, 3-methylpyrrole-5-yl group, 2-t-butylpyrrole-4-yl group, 3-(2-phenylpropyl)pyrrole-1-yl group, 2-methyl-1-indolyl group, 4-methyl-1-indolyl group, 2-methyl-3-indolyl group, 4-methyl-3-indolyl group, 2-t-butyl 1-indolyl group, 4-t-butyl 1-indolyl group, 2-t-butyl 3-indolyl group, 4-t-butyl 3-indolyl group, etc.

Among those, 2-pyridinyl group, 1-indolizinyl group, 2-indolizinyl group, 3-indolizinyl group, 5-indolizinyl group, 6-indolizinyl group, 7-indolizinyl group, 8-indolizinyl group, 2-imidazopyridinyl group, 3-imidazopyridinyl group, 5-imidazopyridinyl group, 6-imidazopyridinyl group, 7-imidazopyridinyl group, 8-imidazopyridinyl group, 3-pyridinyl group, 4-pyridinyl group, 1-indolyl group, 2-indolyl group, 3-indolyl group, 4-indolyl group, 5-indolyl group, 6-indolyl group, 7-indolyl group, 1-iso indolyl group, 2-iso indolyl group, 3-iso indolyl group, 4-iso indolyl group, 5-iso indolyl group, 6-iso indolyl group, 7-iso indolyl group, 1-carbazolyl group, 2-carbazolyl group, 3-carbazolyl group, 4-carbazolyl group and 9-carbazolyl group are preferable.

It is preferable for the aryl group having 6 to 40 nuclear carbon atoms which may have a substituent represented by R₅ to R₃₅ to have 6 to 40 carbon atoms. Examples of the aryl group include phenyl group, 1-naphthyl group, 2-naphthyl group, 1-anthryl group, 2-anthryl group, 9-anthryl group, 1-phenanthryl group, 2-phenanthryl group, 3-phenanthryl group, 4-phenanthryl group, 9-phenanthryl group, 1-naphthacenyl group, 2-naphthacenyl group, 9-naphthacenyl group, 1-pyrenyl group, 2-pyrenyl group, 4-pyrenyl group, 2-biphenyl group, 3-biphenyl group, 4-biphenyl group, p-terphenyl-4-yl group, p-terphenyl-3-yl group, p-terphenyl-2-yl group, m-terphenyl-4-yl group, m-terphenyl-3-yl group, m-terphenyl-2-yl group, o-tolyl group, m-tolyl group, p-tolyl group, p-t-butylphenyl group, p-(2-phenylpropyl)phenyl group, 3-methyl-2-naphthyl group, 4-methyl-1-naphthyl group, 4-methyl-1-anthryl group, 4′-methylbiphenyl-yl group, 4″-t-butyl-p-terphenyl-4-yl group, o-cumenyl group, m-cumenyl group, p-cumenyl group, 2,3-xylyl group, 3,4-xylyl group, 2,5-xylyl group, mesityl group, perfluorophenyl group, etc.

Among those, phenyl group, 1-naphthyl group, 2-naphthyl group, 9-phenanthryl group, 2-biphenyl group, 3-biphenyl group, 4-biphenyl group, p-tolyl group and 3,4-xylyl group are preferable.

The substituted or unsubstituted aryloxy group having 6 to 50 nuclear carbon atoms represented by R₅ to R₃₅ is expressed by —OAr; and examples are the same as those explained about the foregoing aryl group.

It is preferable for the aralkyl group having 7 to 40 carbon atoms which may have a substituent represented by R₅ to R₃₅ to have 7 to 18 carbon atoms. Examples of the aralkyl group include benzyl group, 1-phenylethyl group, 2-phenylethyl group, 1-phenylisopropyl group, 2-phenylisopropyl group, phenyl-t-butyl group, α-naphthylmethyl group, 1-α-naphthyl ethyl group, 2-α-naphthyl ethyl group, 1-α-naphthyl isopropyl group, 2-α-naphthylisopropyl group, β-naphthylmethyl group, 1-β-naphthylethyl group, 2-β-naphthylethyl group, 1-β-naphthylisopropyl group, 2-β-naphthylisopropyl group, 1-pyrrolylmethyl group, 2-(1-pyrrolyl)ethyl group, p-methylbenzyl group, m-methylbenzyl group, o-methylbenzyl group, p-chlorobenzyl group, m-chlorobenzyl group, o-chlorobenzyl group, p-bromobenzyl group, m-bromobenzyl group, o-bromobenzyl group, p-iodobenzyl group, m-iodobenzyl group, o-iodobenzyl group, p-hydroxybenzyl group, m-hydroxybenzyl group, o-hydroxybenzyl group, p-aminobenzyl group, m-aminobenzyl group, o-aminobenzyl group, p-nitrobenzyl, m-nitrobenzyl, o-nitrobenzyl, p-cyanobenzyl group, m-cyanobenzyl group, o-cyanobenzyl group, 1-hydroxy-2-phenylisopropyl group, 1-chloro-2-phenylisopropyl group, etc. Among those, benzyl group, p-cyano benzyl group, m-cyano benzyl group, o-cyano benzyl group, 1-phenylethyl group, 2-phenylethyl group, 1-phenylisopropyl group and 2-phenylisopropyl group are preferable.

It is preferable for the alkenyl group having 2 to 30 carbon atoms which may have a substituent represented by R₅ to R₃₅ to have 2 to 16 carbon atoms. Examples of the alkenyl group include vinyl group, aryl group, 1-butenyl group, 2-butenyl group, 3-butenyl group, 1,3-butanedienyl group, 1-methylvinyl group, styryl group, 2,2-diphenyl vinyl group, 1,2-diphenyl vinyl group, 1-methylallyl group, 1,1-dimethylallyl function, 2-methylallyl group, 1-phenylaryl group, 2-phenylaryl group, 3-phenylaryl group, 3,3-diphenylaryl group, 1,2-dimethylaryl group, 1-phenyl-1-butenyl group, 3-phenyl-1-butenyl group, etc. Among those, styryl group, 2,2-diphenyl vinyl group and 1,2-diphenyl vinyl group are preferable.

The arylamino group having 6 to 80 nuclear carbon atoms which may have a substituent, the alkylamino group having 1 to 60 carbon atoms which may have a substituent and the aralkyl amino group having 7 to 80 carbon atoms which may have a substituent are expressed by —NQ₁Q₂. It is preferable for examples of Q₁ and Q₂ to have each independently 1 to 20 carbon atoms and to be a hydrogen atom, those same examples as explained about the foregoing aryl group, the foregoing alkyl group and the foregoing aralkyl group.

Examples of the alkylsilyl group having 1 to 30 carbon atoms which may have a substituent represented by R₅ to R₃₅ include trimethylsilyl group, triethylsilyl group, t-butyldimethylsilyl group, vinyldimethylsilyl group, propyldimethylsilyl group, etc.

Examples of the arylsilyl group having 6 to 40 carbon atoms which may have a substituent represented by R₅ to R₃₅ include triphenylsilyl group, phenyldimethylsilyl group, t-butyldiphenylsilyl group, etc.

Examples of the halogen atom represented by R₅ to R₃₅ include fluorine atom, chlorine atom, bromine atom, iodine atom, etc.

Examples of the substituent R in the foregoing —S(R)O₂, —S(R)O represented by R₅ to R₃₅ are the same groups explained about R₅ to R₃₅.

Further, examples of the ring structure formed by bonding the adjacent couples among R₂₀ to R₂₇ and among R₂₈ to R₃₅ in the general formulae (4) and (5), and examples of the ring structure formed by bonding a couple of R₇ and R₈, a couple of R₁₀ and R₁₁, a couple of R₁₁ and R₁₂, a couple of R₁₃ and R₁₄, a couple of R₁₄ and R₁₅, a couple of R₁₅ and R₁₆ and a couple of R₁₇ and R₁₈ include a cycloalkane having 4 to 12 carbon atoms such as cyclobutane, cyclopentane, cyclohexane, adamantane, norbornane, etc.; a cycloalkene having 4 to 12 carbon atoms such as cyclobutene, cyclopentene, cyclohexene, cyclo heptene, cyclo octene, etc.; a cycloalkadiene having 6 to 12 carbon atoms such as cyclohexadiene, cycloheptadiene, cyclo octadiene, etc.; an aromatic ring having 6 to 50 carbon atoms such as benzene, naphthalene, phenanthrene, anthracene, pyrene, chrysene, acenaphthylene, etc.; and so on.

In the metal-complex compound of the present invention, it is preferable that the partial structure (L₁)ₘM expressed by the general formula (2) is represented by the general formula (4) or the general formula (5); and that the partial structure M(L₂)ₙ expressed by the general formula (3) is represented by any one of the general formulae (6) to (10).

In the metal-complex compound of the present invention it is more preferable that the partial structure (L₁)ₘM expressed by the general formula (2) is represented by the general formula (4) or the general formula (5); that the partial structure M(L₂)ₙ expressed by the general formula (3) is represented by any one of the general formulae (6) to (10); and that m is an integer of 2, n is an integer of 1, and M is an iridium atom.

Specific examples of the metal-complex compound represented by general formula (1) of the present invention are as follows, however, the present invention is not limited to these typical compounds.

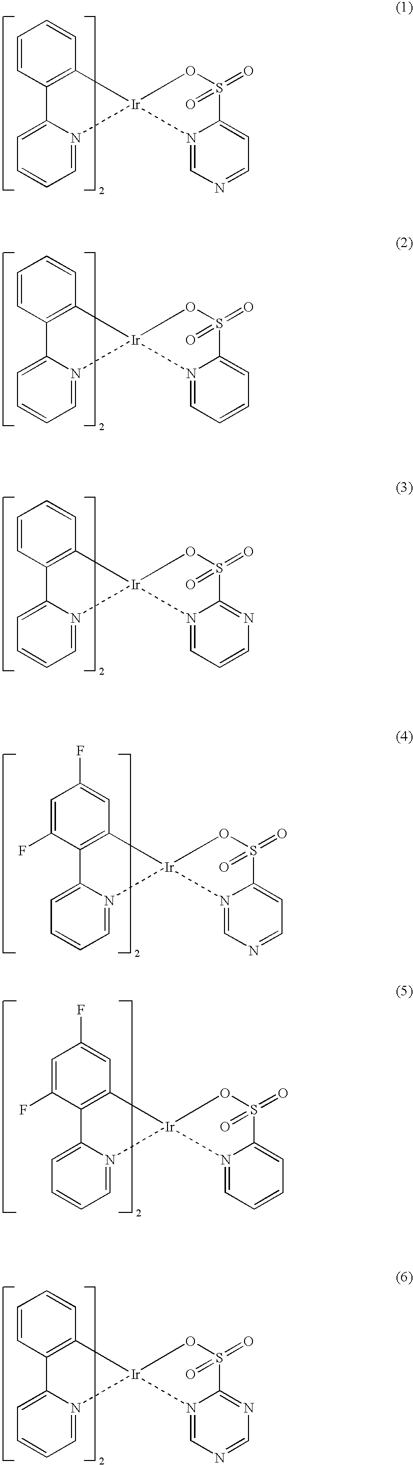

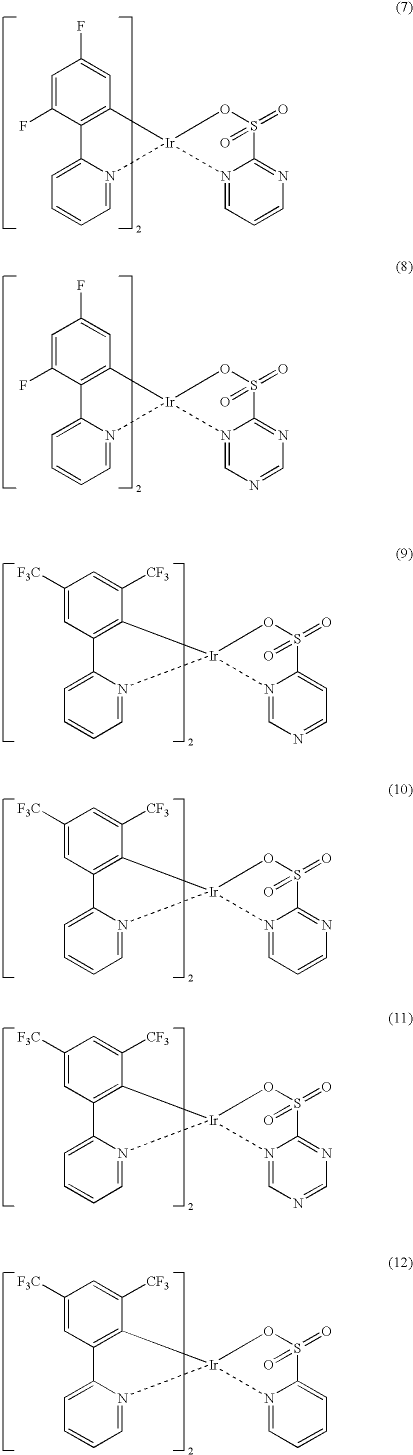

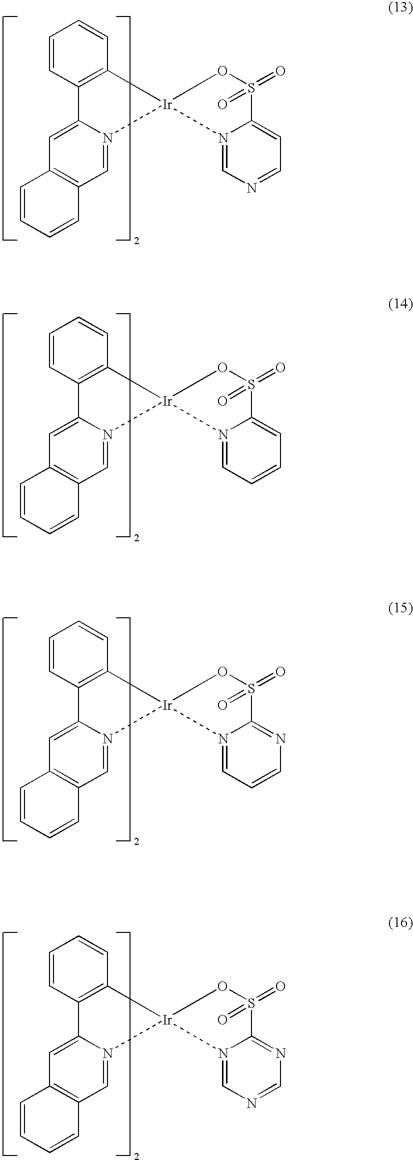

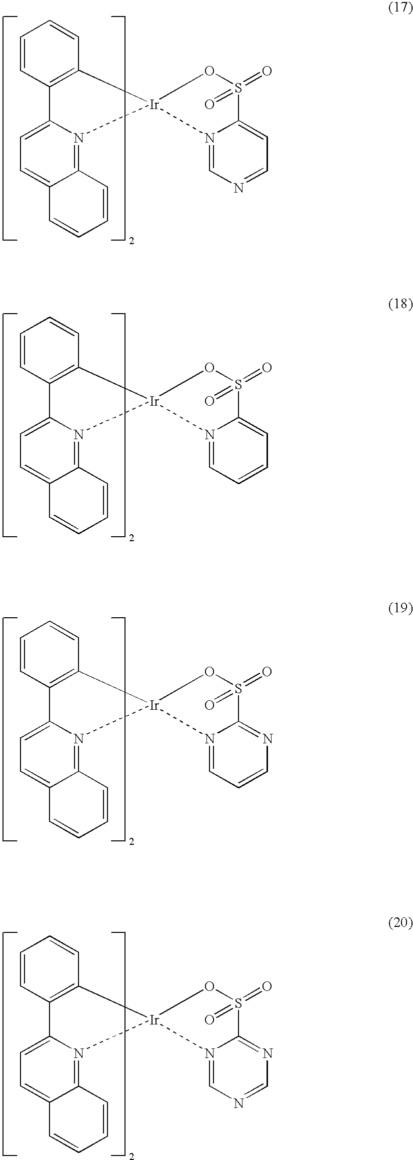

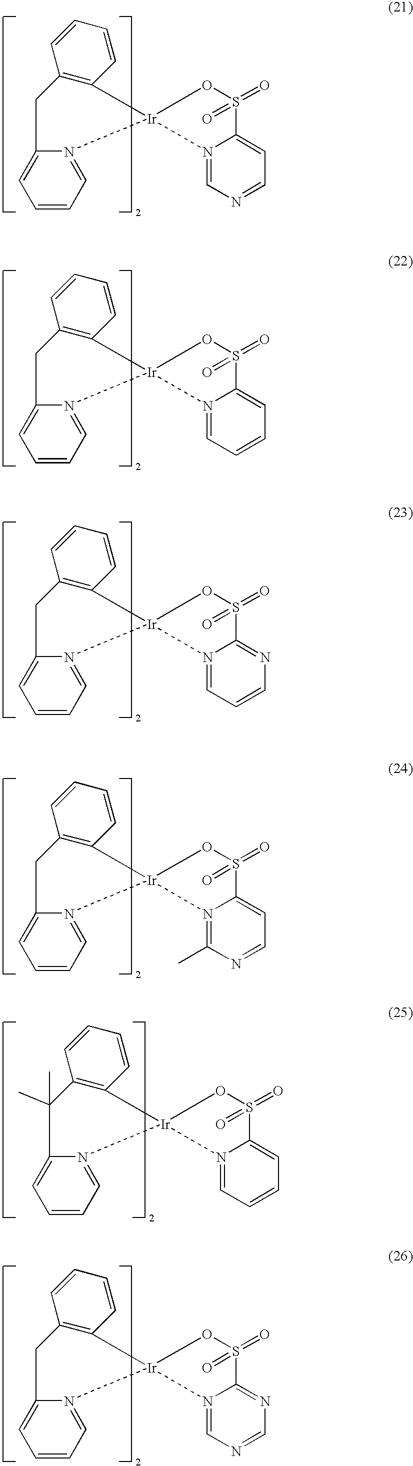

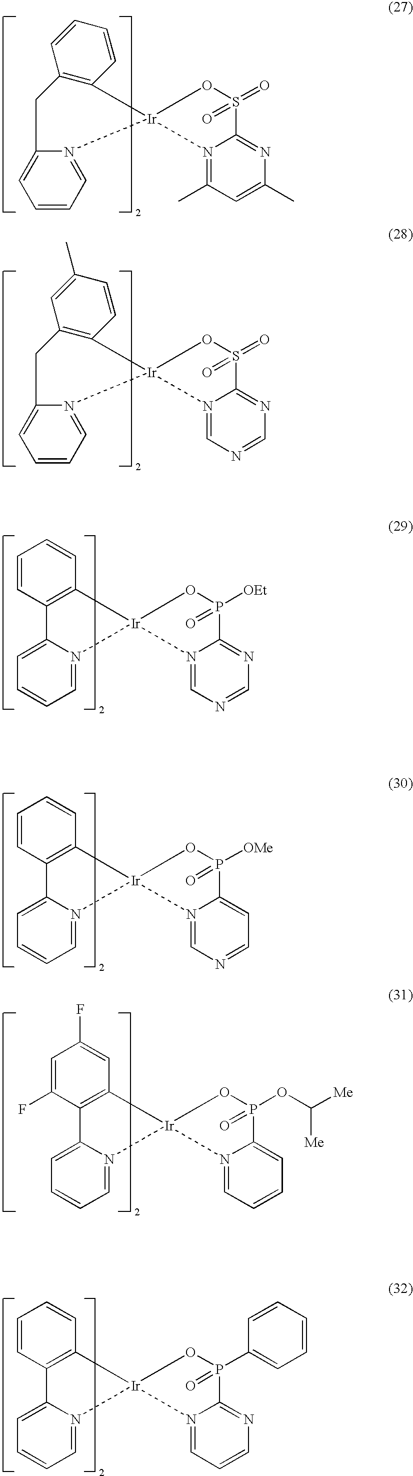

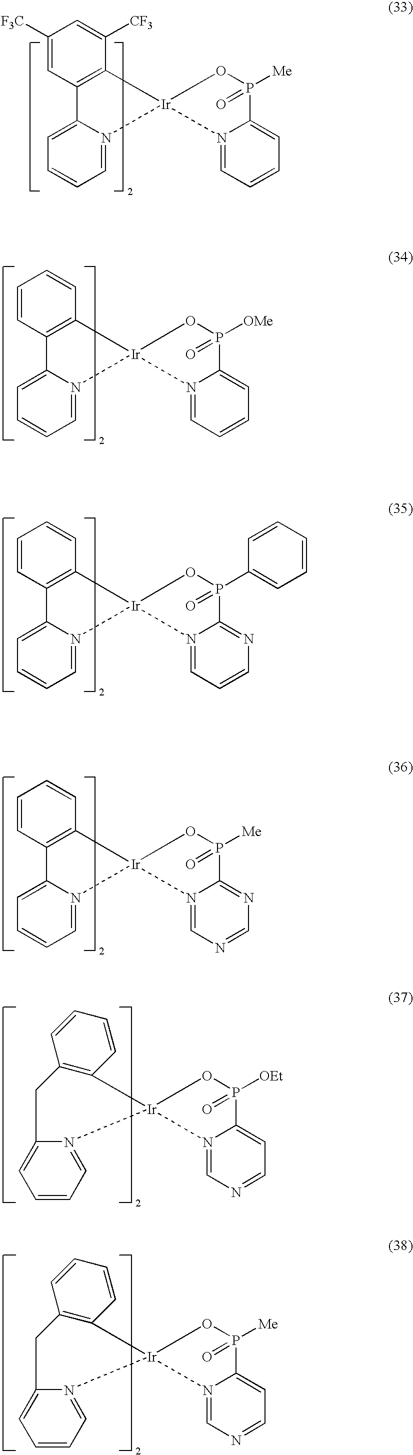

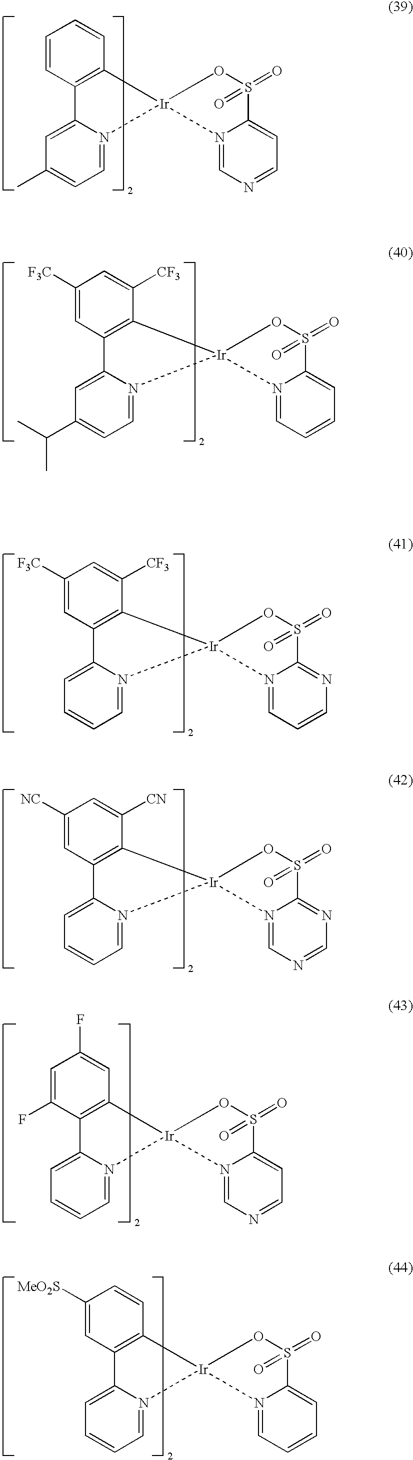

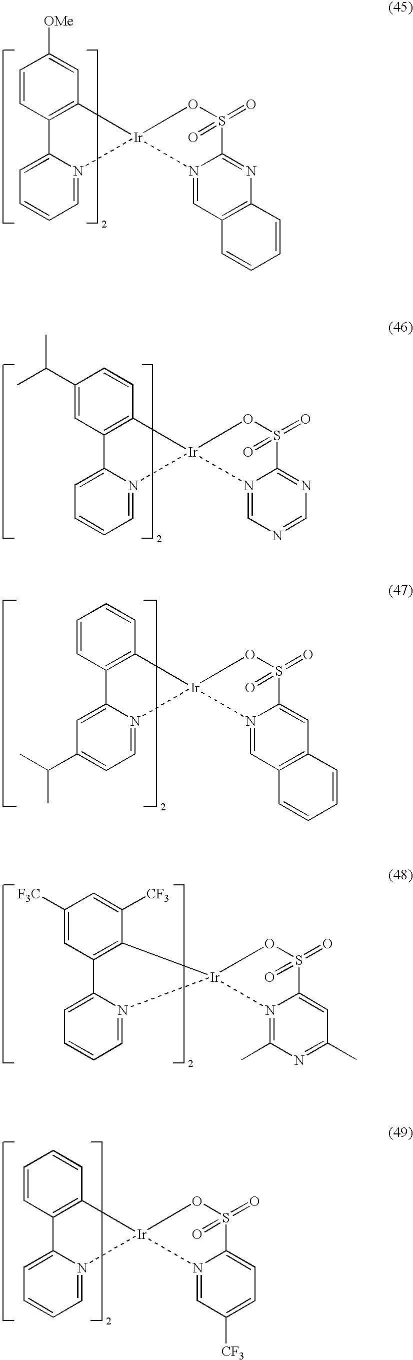

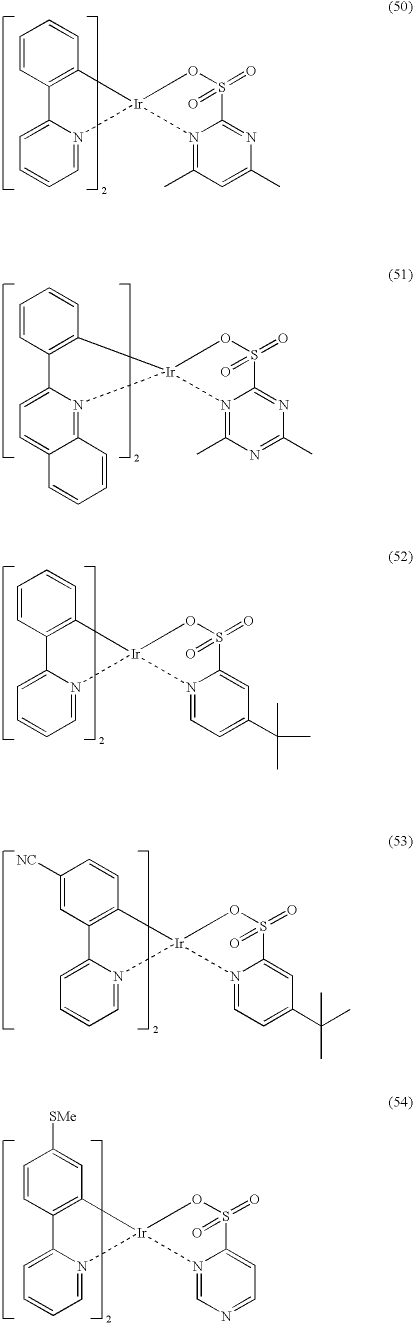

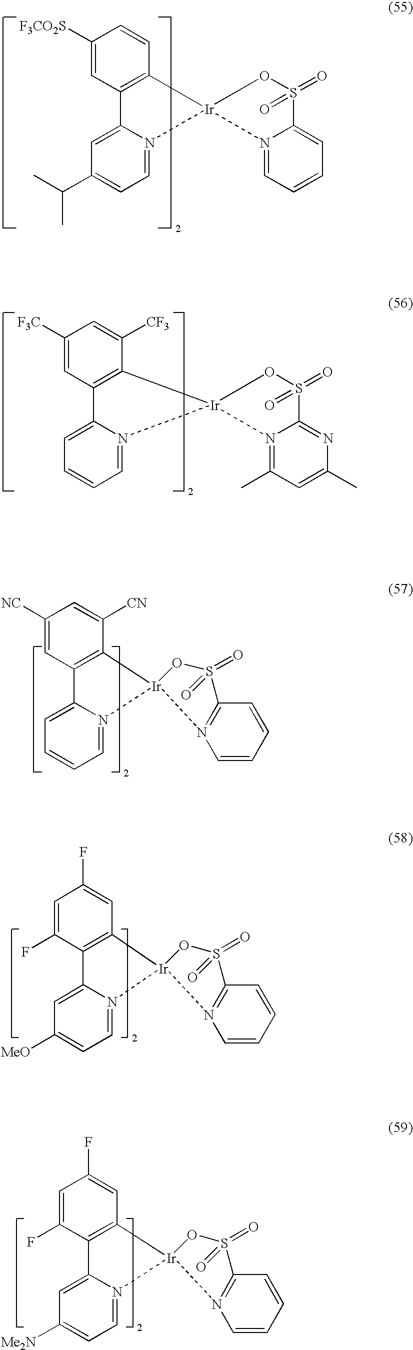

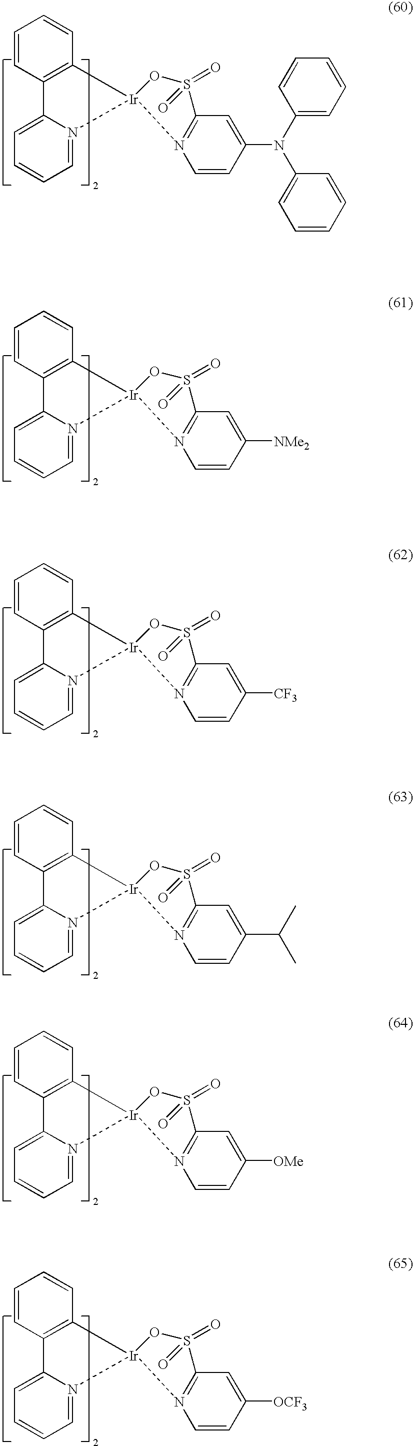

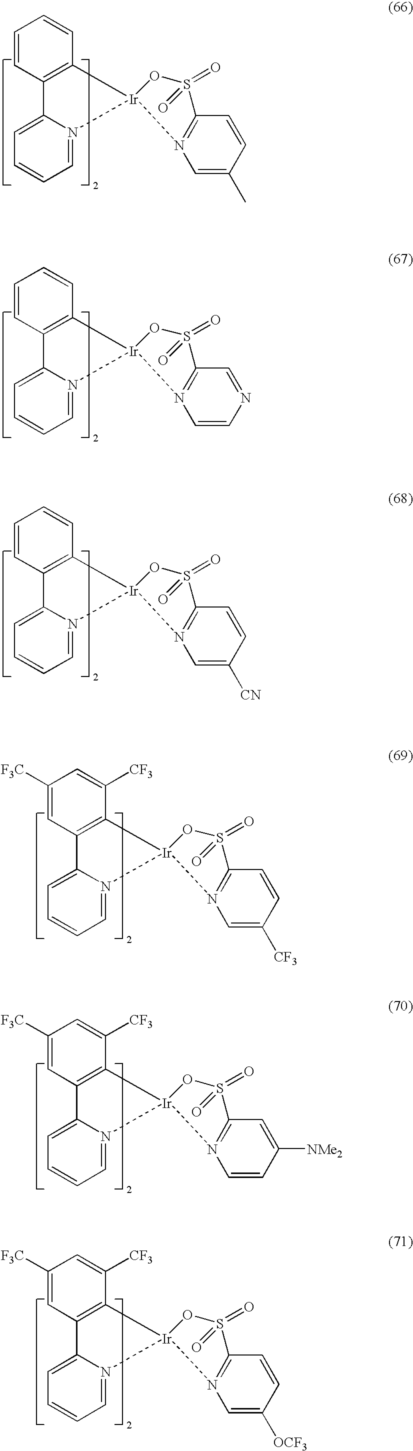

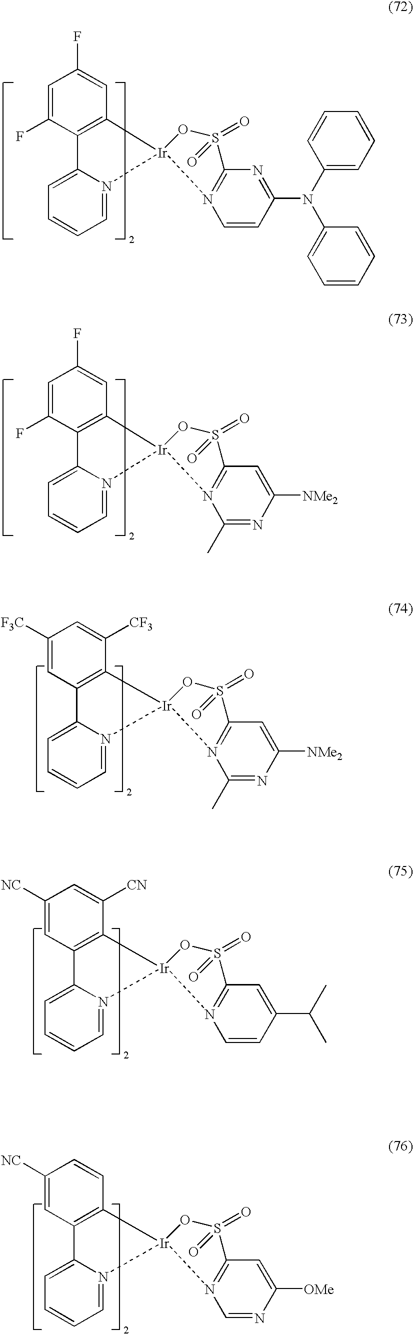

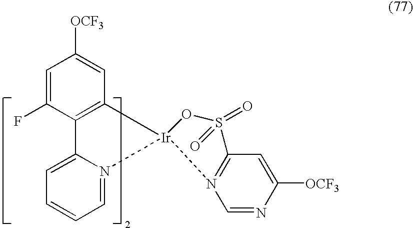

The present invention provides an organic EL device which comprises at least one organic thin film layer sandwiched between a pair of electrodes consisting of an anode and a cathode, wherein the organic thin film layer comprises the above metal-complex compound.

With regard to the amount of the metal-complex compound of the present invention contained in the organic thin film layer, it is usually 0.1 to 100% by weight, preferably 1 to 30% by weight of total weight of the light emitting layer.

It is preferable for the organic EL device of the present invention that the light emitting layer comprises the metal-complex compound of the present invention. Further, the light emitting layer is usually formed to a thin film by means of vapor deposition process or coating process, however, it is preferable that the layer comprising the metal-complex compound of the present invention is formed into film by coating process because it simplifies the production process.

In the organic EL device of the present invention, a monolayer-type organic thin layer consists of a light emitting layer, which comprises the metal-complex compound of the present invention. Typical examples of the construction of the organic EL device include (i) an anode/a hole injecting layer (a hole transporting layer)/a light emitting layer/a cathode; (ii) an anode/a light emitting layer/an electron injecting layer (an electron transporting layer)/a cathode; (iii) an anode/a hole injecting layer (a hole transporting layer)/a light emitting layer/an electron injecting layer (an electron transporting layer)/a cathode.

The anode in the organic EL device covers a role of injecting holes into a hole injecting layer, a hole transporting layer or into a light emitting layer, and it is effective that the anode has a work function of 4.5 eV or greater. As the material for the anode, metals, alloys, metal oxides, electroconductive compounds, or these mixtures may be employable. Specific examples of the material for the anode include electroconductive metal oxides such as tin oxide, zinc oxide, indium oxide, indium tin oxide (ITO), etc.; metals such as gold, silver, chromium, nickel, etc.; mixtures or laminated materials of these electroconductive metal oxide and metals; inorganic electroconductive substance such as copper iodide, chalocite, etc.; organic electroconductive materials such as polyaniline, polythiophene, polypyrrole, etc.; and laminated materials of the above materials with ITO. Regarding with a film thickness of the anode, it is possible to be appropriately selected depending on the material.

The cathode in the organic EL device covers a role of injecting electrons into an electron injecting layer, an electron transporting layer or into a light emitting layer. As the material for the anode, metals, alloys, metal oxides, electroconductive compounds, or these mixtures may be employable. Specific examples of the material for the cathode include alkali metals (for example, Li, Na, K, etc.) and their fluoride or oxide, alkaline earth metals (for example, Mg, Ca, etc.) and their fluoride or oxide, gold, silver, lead, aluminum, sodium-potassium alloy or sodium-potassium mixed metals, lithium-aluminum alloy or lithium-aluminum mixed metals, magnesium-silver alloy or the magnesium-silver mixed metals, or rare earth metals such as indium, ytterbium, etc. Among these, preferable examples are aluminum, lithium-aluminum alloy or lithium-aluminum mixed metals, magnesium-silver alloy or magnesium-silver mixed metals, etc. The cathode may be a monolayer structure of the above material, and may be a laminated structure of the layer containing the above material. For example, the laminated structure such as aluminum/lithium fluoride, aluminum/lithium oxide or the like is preferable. Regarding with a film thickness of the cathode, it is possible to be appropriately selected depending on the material.

It may be appropriate that the hole injecting layer and the hole transporting layer of the organic EL device of the present invention have any function of injecting holes from the anode, transporting holes, or barriering the electrons injected from the cathode. Specific examples include carbazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino substituted chalcone derivatives, styryl anthracene derivatives, fluorenone derivatives, hydrazone derivatives, stilbene derivatives, silazane derivatives, aromatic tertiary amine compounds, styryl amine compound, aromaticdimethylidene-based compounds, porphyrin-based compounds, polysilane-based compounds, poly(N-vinylcarbazole) derivatives, aniline-based copolymer; electroconductive polymer oligomer such as thiophene oligomer, polythiophene, etc.; organosilane derivatives, metal-complex compound of the present invention, etc. The hole injecting layer and the hole transporting layer may be composed of single layer comprising one or more kind of these hole injecting materials and these hole transporting materials or may be laminated with themselves or a layer comprising another kind of compound.

It may be appropriate that the electron injecting layer and the electron transporting layer of the organic EL device of the present invention have any function of injecting electrons from the cathode, transporting electrons, or barriering the holes injected from the anode. Specific examples include triazole derivatives, oxazole derivatives, oxadiazole derivatives, midazole derivatives, fluorenone derivatives, anthraquinodimethane derivatives, anthrone derivatives, diphenylchinone derivatives, thiopyrandioxide derivatives, carbodiimide derivatives, fluorenylidene methane derivatives, distyrylpyrazine derivatives; aromatic ring tetracarboxylic acid anhydride such as naphthalene, perylene, etc.; Phthalocyanine derivatives, various metallic complexes represented by metallic complexes of 8-quinolinol derivatives or metallic complexes having benz oxazole or benzothiazole as ligand; organosilane derivatives, metal-complex compound of the present invention, etc. The electron injecting layer may be composed of single layer comprising one or more kind of these electron injecting materials or may be laminated with an electron injecting layer comprising another kind of compound.

Further, following compounds illustrate electron transporting materials employable for the electron injecting layer and the electron transporting layer.

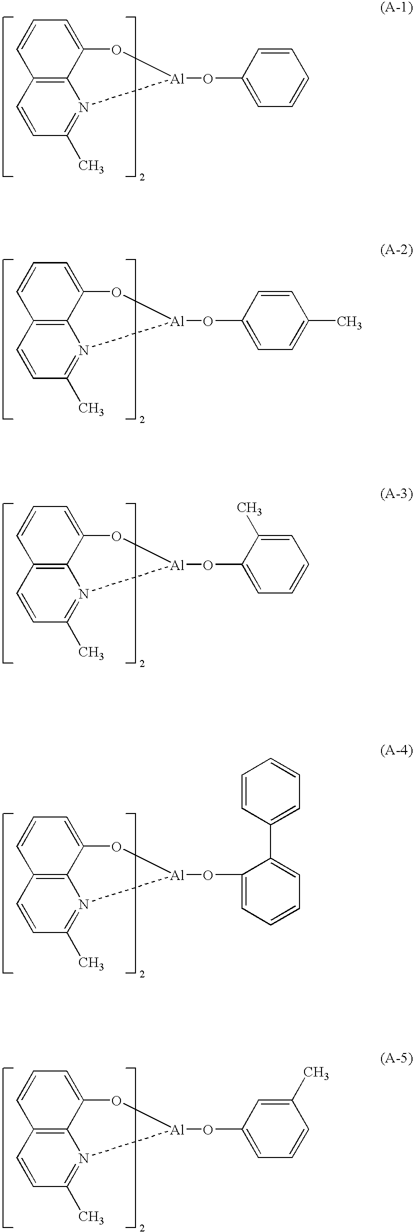

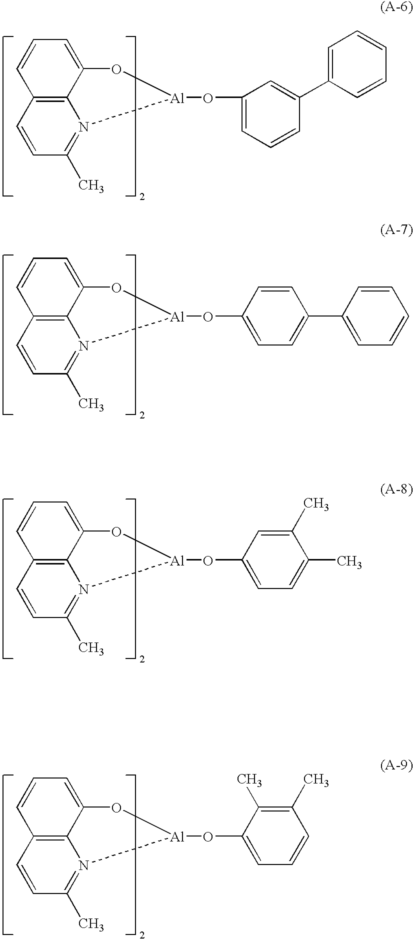

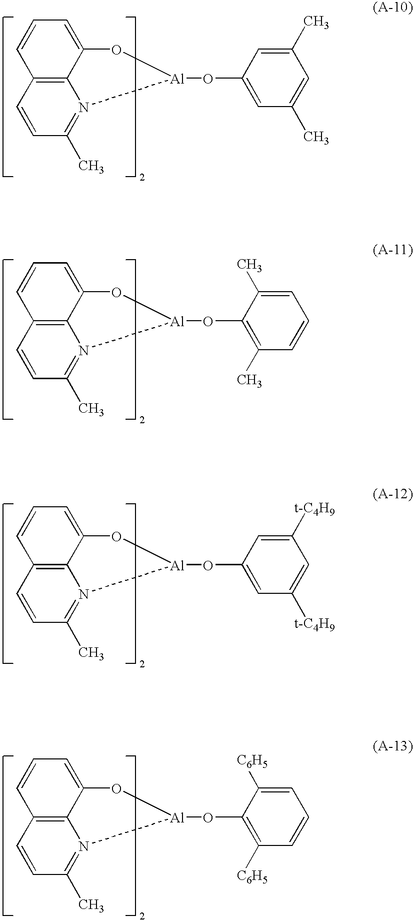

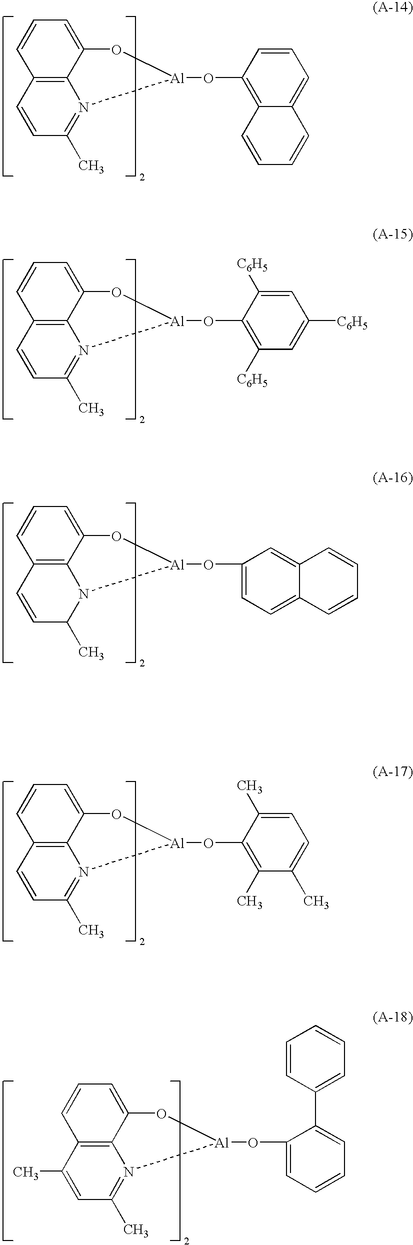

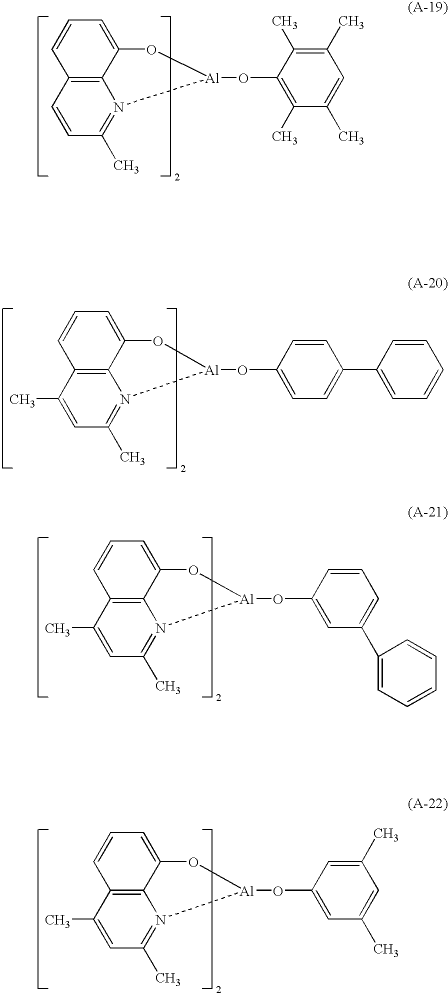

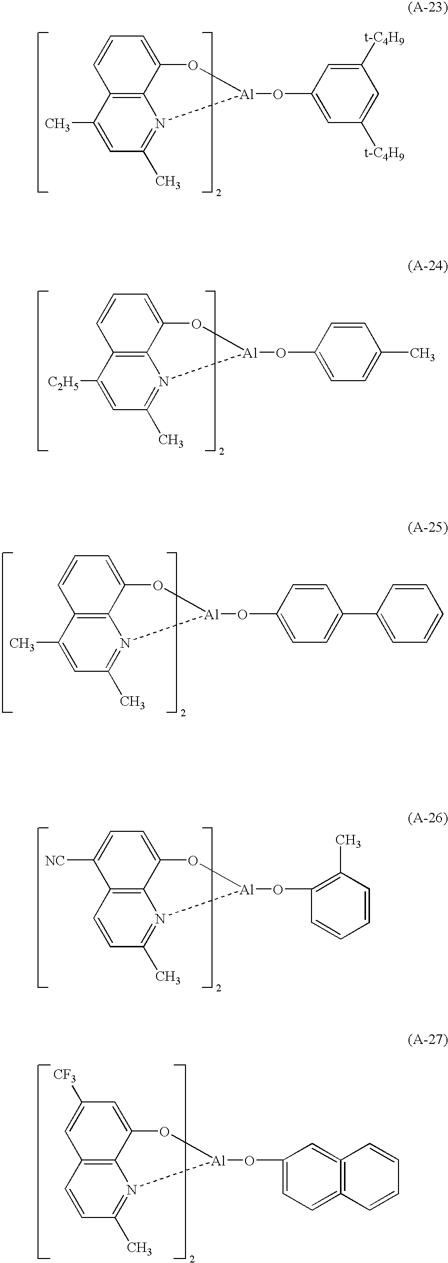

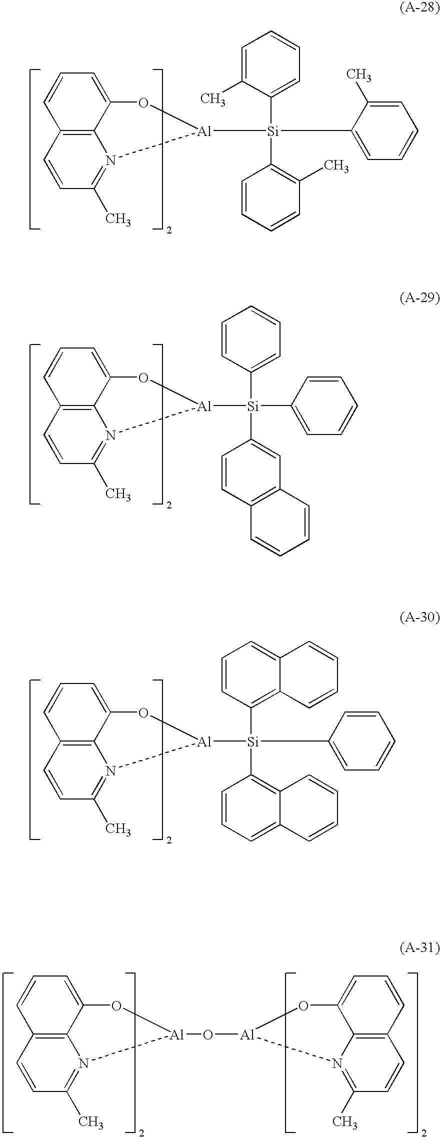

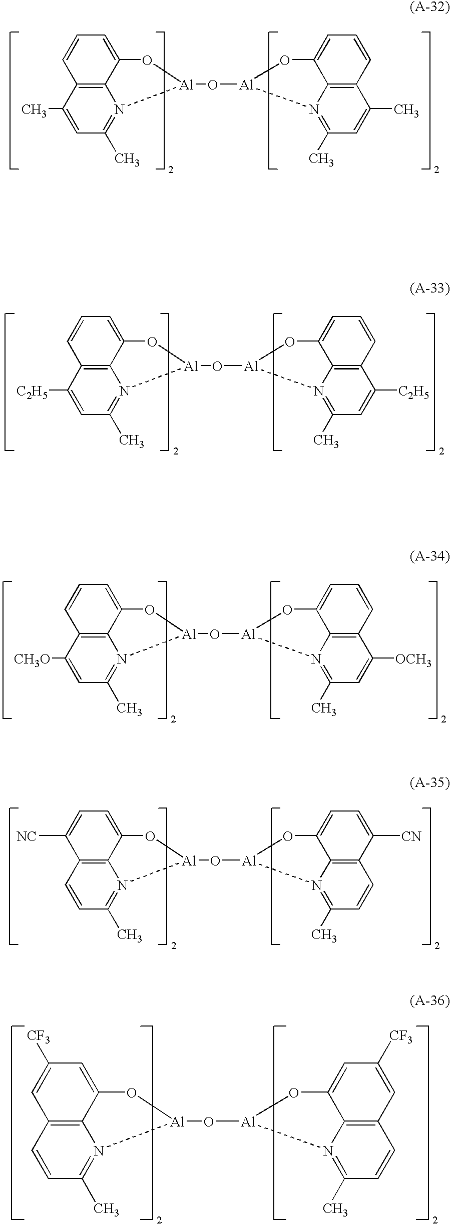

It is preferable for the organic EL device of the present invention that the electron injecting layer and/or the electron transporting layer comprises a π-electron lacking heterocyclic derivative having a nitrogen atom as its essential component.

Preferable examples of the π-electron lacking heterocyclic derivative having a nitrogen atom include derivatives of five-member ring having a nitrogen atom selected from among benzimidazole ring, benztriazole ring, pyridino imidazole ring, pyrimidino imidazole ring, pyridazino imidazole ring; or derivatives of six-member ring having a nitrogen atom consisting of pyridine ring, pyrimidine ring, pyrazine ring or triazine ring. A structure expressed by general formula B-I below is preferable as the derivatives of five-member ring having a nitrogen atom. Structures expressed by general formulae C-I, C-II, C-III, C-IV, C-V and C-VI below are preferable as the derivatives of six-member ring having a nitrogen atom, while general formulae C-I and C-II are more preferable.

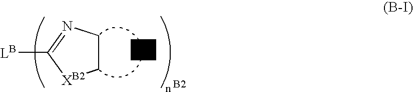

In general formula (B-I), LB represents a connecting group of divalent or more, preferably the connecting group formed with a carbon atom, a silicon atom, a nitrogen atom, a boron atom, an oxygen atom, a sulfur atom, a metal, a metal ion, etc.; more preferably the connecting group formed with a carbon atom, a silicon atom, a nitrogen atom, a boron atom, an oxygen atom, a sulfur atom, an aromatic hydrocarbon ring, an aromatic heterocycle and the most preferably the connecting group formed with a carbon atom, a silicon atom, an aromatic hydrocarbon ring and an aromatic heterocycle.

L^{B} may have a substituent, and preferable examples of the substituent are alkyl group, alkenyl group, alkynyl group, aromatic hydrocarbon radical, amino group, alkoxy group, aryloxy group, acyl group, alkoxycarbonyl group, aryloxy carbonyl group, acyl oxy group, acylamino group, alkoxycarbonylamino group, aryloxy carbonylamino group, sulfonyl amino group, sulfamoyl group, carbamoyl group, alkylthio group, arylthio group, sulphonyl group, halogen atom, cyano group and aromatic heterocyclic group; more preferable examples are alkyl group, aryl group, alkoxy group, aryloxy group, halogen atom, cyano group and aromatic heterocyclic group; furthermore preferable examples are alkyl group, aryl group, alkoxy group, aryloxy group and aromatic heterocyclic group; and particularly preferable examples are alkyl group, aryl group, alkoxy group and aromatic heterocyclic group.

Followings are the specific examples of the connecting group represented by L^{B}:

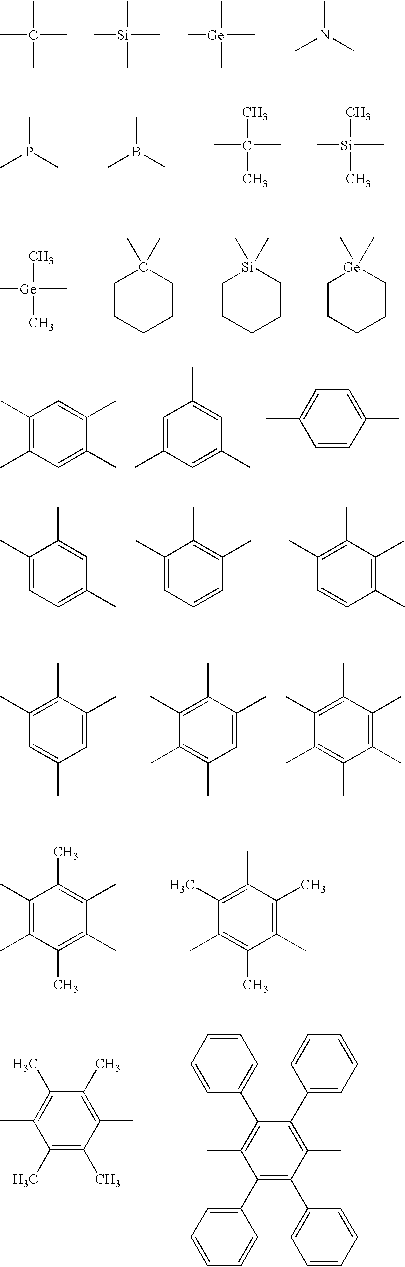

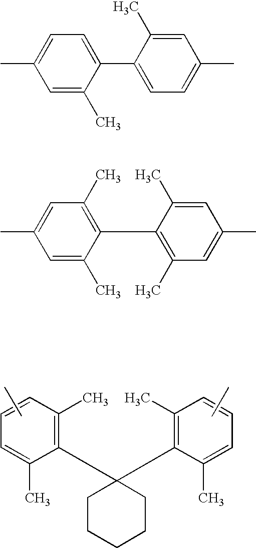

In the general formula (B-I), X^{B2} represents —O—, —S— or ═N—R^{B2}. R^{B2} represents a hydrogen atom, an aliphatic hydrocarbon group, an aryl group and a heterocyclic group.

The aliphatic hydrocarbon group represented by R^{B2} are straight chain, branched or circular alkyl group (alkyl group preferably having 1 to 20 carbon atoms, more preferably having 1 to 12 carbon atoms and particularly preferably having 1 to 8 carbon atoms; examples include methyl group, ethyl group, iso-propyl group, tert-butyl group, n-octyl group, n-decyl group, n-hexadecyl group, cyclopropyl group, cyclopentyl group, cyclohexyl group, etc.); alkenyl group (alkenyl group preferably having 2 to 20 carbon atoms, more preferably having 2 to 12 carbon atoms and particularly preferably having 2 to 8 carbon atoms; examples include vinyl group, aryl group, 2-butenyl group, 3-pentenyl group, etc.); and alkynyl group (alkynyl group preferably having 2 to 20 carbon atoms, more preferably having 2 to 12 carbon atoms and particularly preferably having 2 to 8 carbon atoms; examples include propargyl group, 3-pentynyl group, etc.), while the above alkyl group being more preferable.

The aryl group represented by R^{B2} is a monocyclic or condensed ring aryl group, preferably the aryl group having 6 to 30 carbon atoms, more preferably 6 to 20 carbon atoms and further preferably 6 to 12 carbon atoms; examples include phenyl group, 2-methylphenyl group, 3-methylphenyl group, 4-methylphenyl group, 2-methoxyphenyl group, 3-trifluoromethylphenyl group, pentafluorophenyl group, 1-naphthyl group, 2-naphthyl group, etc.

The heterocyclic group represented by R^{B2} is a monocyclic or condensed ring heterocyclic group, preferably the heterocyclic group having 1 to 20 carbon atoms, more preferably 1 to 12 carbon atoms and further preferably 2 to 10 carbon atoms; examples include pyrrolidine, piperidine, piperazine, morpholine, thiophene, selenophene, furan, pyrrole, glyoxaline, pyrazole, pyridine, pyrazine, pyridazine, pyrimidine, triazole, triazine, indole, indazole, purine, thiazoline, thiazole, thiadiazole, oxazoline, oxazole, oxadi azole, chinoline, isoquinoline, phthalazine, naphthyridine, quinoxaline, quinazoline, quinoliine, pteridine, acridine, phenanthroline, phenazine, tetrazole, benzimidazole, benz oxazole, benzothiazole, benz triazole, tetrazaindene, carbazole, azepin, etc.; while furan, thiophene, pyridine, pyrazine, pyrimidine, pyridazine, triazine, quinoline, phthalazine, naphthyridine, quinoxaline and quinazoline are preferable; furan, thiophene, pyridine and quinoline are more preferable; and quinoline is further more preferable.

The aliphatic hydrocarbon group, the aryl group and the heterocyclic group represented by R^{B2} may have a substituent whose examples are the same as the above preferable examples of the substituent of L^{B}.

The alkyl group, the aryl group and the aromatic heterocyclic group are preferable as R^{B2}, the aryl group and the aromatic heterocyclic group are more preferable and the aryl group is further more preferable.

In the general formula (B-I), X^{B2} is preferably —O— or ═N—R^{B2}, more preferably ═N—R^{B2} and particularly preferably ═N—Ar^{B2}; while Ar^{B2} is an aryl group (preferably the aryl group having 6 to 30 carbon atoms, more preferably 6 to 20 carbon atoms and further more preferably 6 to 12 carbon atoms); or an aromatic heterocyclic group (preferably the aromatic heterocyclic group having 1 to 20 carbon atoms, more preferably 1 to 12 carbon atoms and further more preferably 2 to 10 carbon atoms).

In the general formula (B-I), Z^{B2} represents an atomic group necessary for forming an aromatic group ring. The aromatic group ring formed by Z^{B2} may be any of an aromatic hydrocarbon ring or an aromatic heterocycle; examples include benzene ring, pyridine ring, pyrazine ring, pyrimidine ring, pyridazine ring, triazine ring, pyrrole ring, furan ring, thiophene ring, selenophene ring, tellurophene ring, imidazole ring, thiazole ring, selenazole ring, tellurazole ring, thiadiazole ring, oxadiazole ring, pyrazole ring, etc.; while benzene ring, pyridine ring, pyrazine ring, pyrimidine ring and pyridazine ring are preferable; benzene ring, pyridine ring and pyrazine ring are more preferable; benzene ring and pyridine ring are further more preferable; and pyridine ring is particularly preferable. The aromatic group ring formed by Z^{B2} may form a condensed ring with other ring or may have a substituent. Preferable substituents for Z^{B2} are alkyl group, alkenyl group, alkynyl group, aryl group, amino group, alkoxy group, aryloxy radical, acyl group, alkoxycarbonyl group, aryloxy carbonyl group, acyl oxy group, acylamino group, alkoxycarbonylamino group, aryloxy carbonylamino group, sulfonyl amino group, sulfamoyl group, carbamoyl group, alkylthio group, arylthio group, sulphonyl group, halogen atom, cyano group and heterocyclic group; more preferable substituents for Z^{B2} are alkyl group, aryl group, alkoxy group, aryloxy group, halogen atom, cyano group and heterocyclic group; further more preferable substituent for Z^{B2} are alkyl group, aryl group, alkoxy group, aryloxy group and heterocyclic group; particularly preferable substituent for Z^{B2} are alkyl group, aryl group, alkoxy group and heterocyclic group.

In the general formula (B-I), n^{B2} represents an integer of 1 to 4, preferably an integer of 2 or 3.

Among the compounds expressed by the general formula (B-I), further preferable compounds are expressed by a following general formula (B-II):

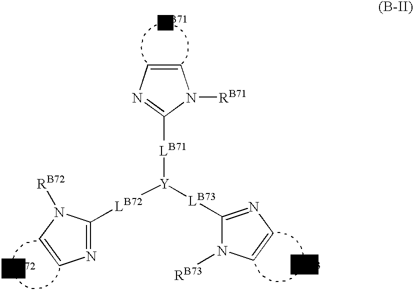

In the general formula (B-II), R^{B71}, R^{B72} and R^{B73} each represents the same as X^{B2} in the general formula (B-I), wherein the preferable examples are also the same.

In the general formula (B-II), Z^{B71}, Z^{B72} and Z^{B73} each represents the same as Z^{B2} in the general formula (B-I), wherein the preferable examples are also the same.

In general formula (B-II), L^{B71}, L^{B72} and L^{B73} each represents a connecting group of divalent or more described as the examples of L^{B} in the general formula (B-I); preferably a single bond, a divalent aromatic hydrocarbon ring group, a divalent aromatic heterocyclic group; and the connecting group formed by those combination; more preferably a single bond. L^{B71}, L^{B72} and L^{B73} may have a substituent, whose examples are the same as described as the substituent for LB in the general formula (B-I).

In general formula (B-II), Y represents a nitrogen atom, a 1,3,5-benzenetriyl group or a 2,4,6-triazinetriyl group. The 1,3,5-benzenetriyl group may have substituent at 2, 4 and 6-positions, examples of the substituent include alkyl group, aromatic hydrocarbon ring group, halogen atom, etc.

Specific examples of the derivatives of five-member ring having a nitrogen atom represented by the general formula (B-I) or the general formula (B-II) include the following compounds, though not limited thereto. 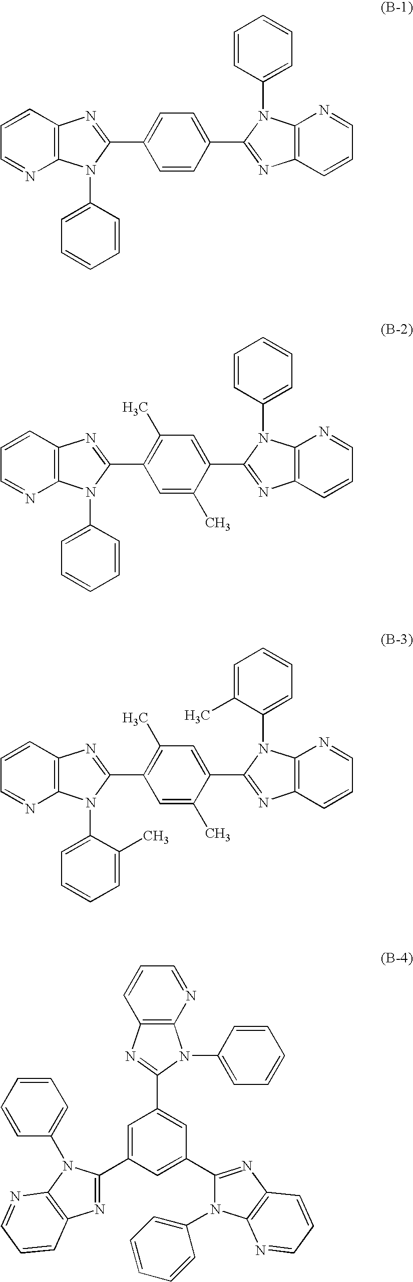 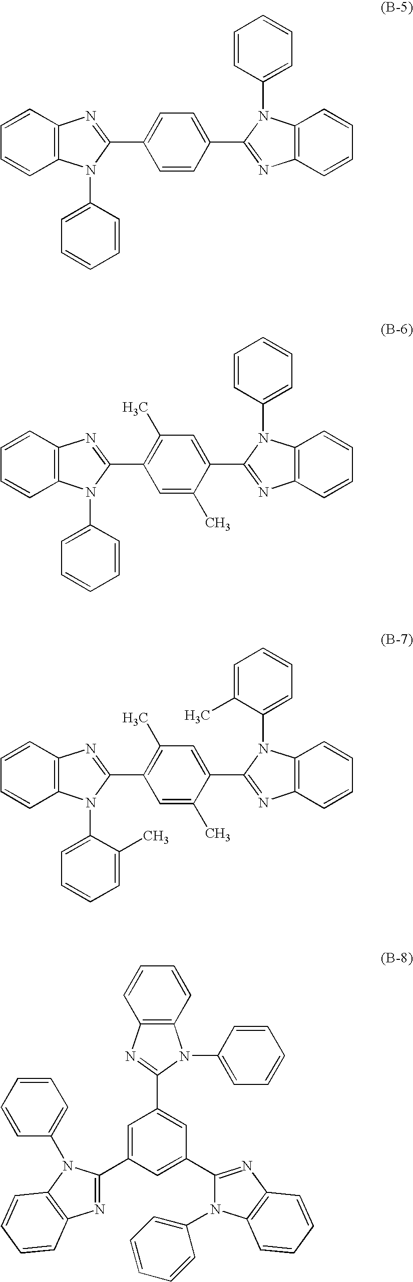 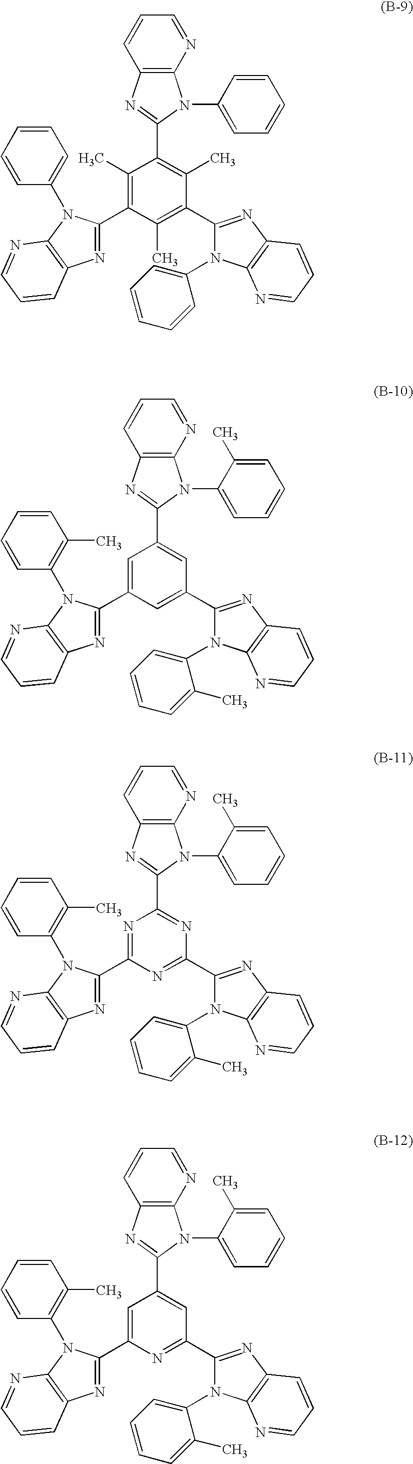 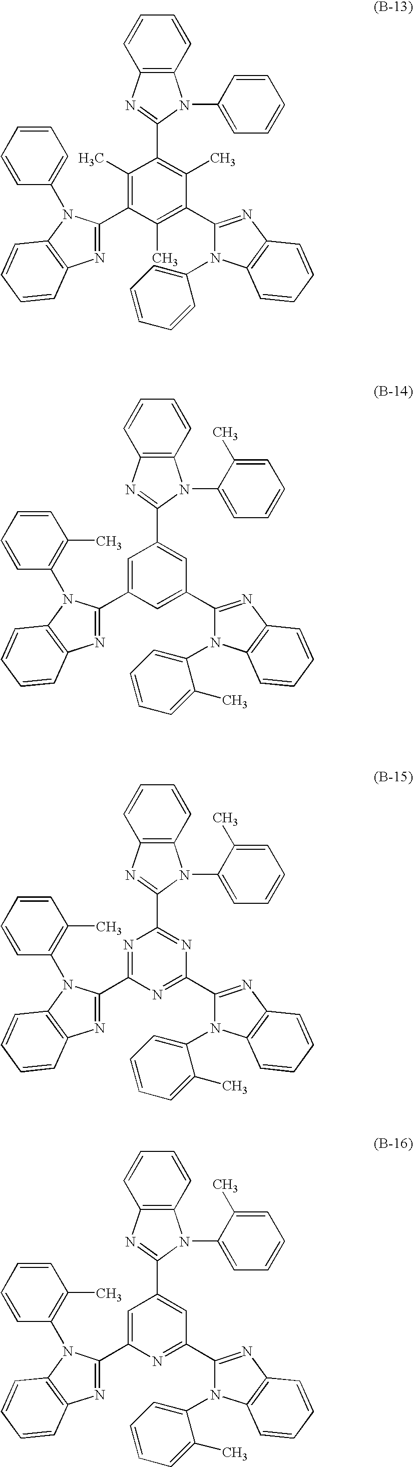
(Cz-)ₙA (C-I)
Cz(-A)ₘ (C-II)
wherein Cz represents a substituted or unsubstituted carbazolyl group, an aryl carbazolyl group or a carbazolylalkylene group; A represents a group formed by a portion expressed by a following general formula (A); and n and m each represents an integer of 1 to 3.
(M)ₚ-(L)_{q}-(M′)ᵣ (A)
wherein M and M′ each independently represents a heteroaromatic ring having a nitrogen atom and further having 2 to 40 carbon atoms, which forms a ring with or without a substituent; further, M and M′ may be the same with or different from each other; L represents a single bond, an arylene group having 6 to 30 carbon atoms, a cycloalkylene group of having 5 to 30 carbon atoms or a heteroaromatic ring having 2 to 30 carbon atoms, each may have or may not have a substituent which bonds to the ring; p represents an integer of 0 to 2, q represents an integer of 1 or 2 and r represents an integer of 0 to 2. However, p plus r makes 1 or greater.

Coupling styles of the general formula (C-I) and the general formula (C-II) are expressed in the following tables concretely depending on a number of parameters n and m.

TABLE 1

| n = m = 1 | n = 2 | n = 3 | m = 2 | m = 3 |
|---|---|---|---|---|
| 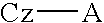 | 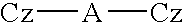 | 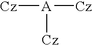 | 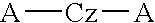 | 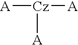 |

Further, coupling styles of the groups represented by general formula (A) are expressed as (1) to (16) in the following Tables concretely depending on a value of parameters p, q and r.

TABLE 2

| No. | p | q | r | Coupling styles |
|---|---|---|---|---|
| (1) | 0 | 1 | 1 | L—M′ |
| (2) | 0 | 1 | 2 | L—M′—M′, M′—L—M′ |
| (3) | 0 | 2 | 1 | L—L—M′, L—M′—L |
| (4) | 0 | 2 | 2 | L—L—M′—M′, M′—L—L—M′, |
| | | | | 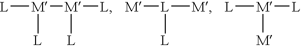 |
| (5) | 1 | 1 | 0 | The same as (1). (Read M′ as M.) |
| (6) | 1 | 1 | 1 | M—L—M′ |
| (7) | 1 | 1 | 2 | 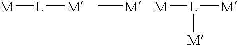 |
| (8) | 1 | 2 | 0 | The same as (3). (Read M′ as M.) |
| (9) | 1 | 2 | 1 | M—L—L—M′, L—M—L—M′, M—L—M′—L |

TABLE 3

| | | | | |
|---|---|---|---|---|
| (10) | 1 | 2 | 2 | M—L—L—M′—M′, M′—L—M—L—M′, |
| | | | | M′—M′—L—M—L, |
| | | | | 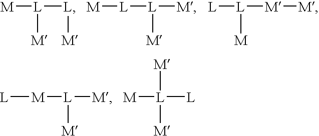 |
| (11) | 2 | 1 | 0 | The same as (2). (Read M′ as M.) |
| (12) | 2 | 1 | 1 | The same as (7). (Read M′ as M.) |
| (13) | 2 | 1 | 2 | M—M—L—M′—M′, |
| | | | | 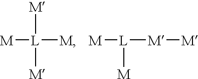 |
| (14) | 2 | 2 | 0 | The same as (4). (Read M′ as M.) |
| (15) | 2 | 2 | 1 | The same as (10.) (Read M′ as M.) |
| (16) | 2 | 2 | 2 | M—M—L—L—M′—M′, |
| | | | | 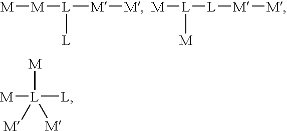 |
| | | | | 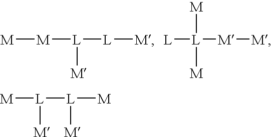 |

In the general formulae (C-I) and (C-II), when Cz couples with A, Cz may bond at any position of M, L or M′ expressing A For example, in a case where p=q=r=1 ((6) in [Table 2]) in Cz-A wherein m=n=1, A becomes as M-L-M′ and expressed by three coupling styles of Cz-M-L-M′, M-L(-Cz)-M′ and M-L-M′-Cz. In the same way, in a case where p=q=1 and r=2 ((7) in [Table 2]) in Cz-A-Cz wherein n=2 in the general formula (C-I), A becomes as M-L-M′-M′ or M-L(-M′)-M′ and expressed by following coupling styles:

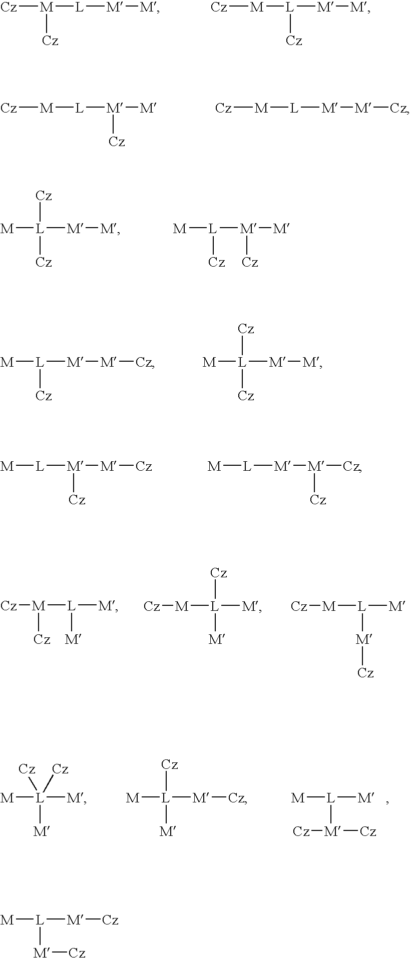

Specific examples of the structure represented by general formulae (C-I) and (C-II) include the structures shown in the following, however, they are not limited to the following. 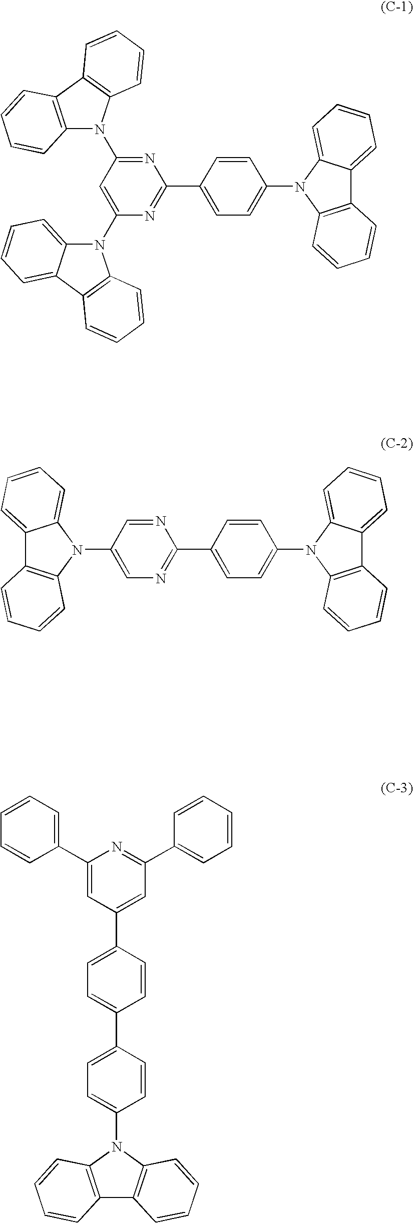 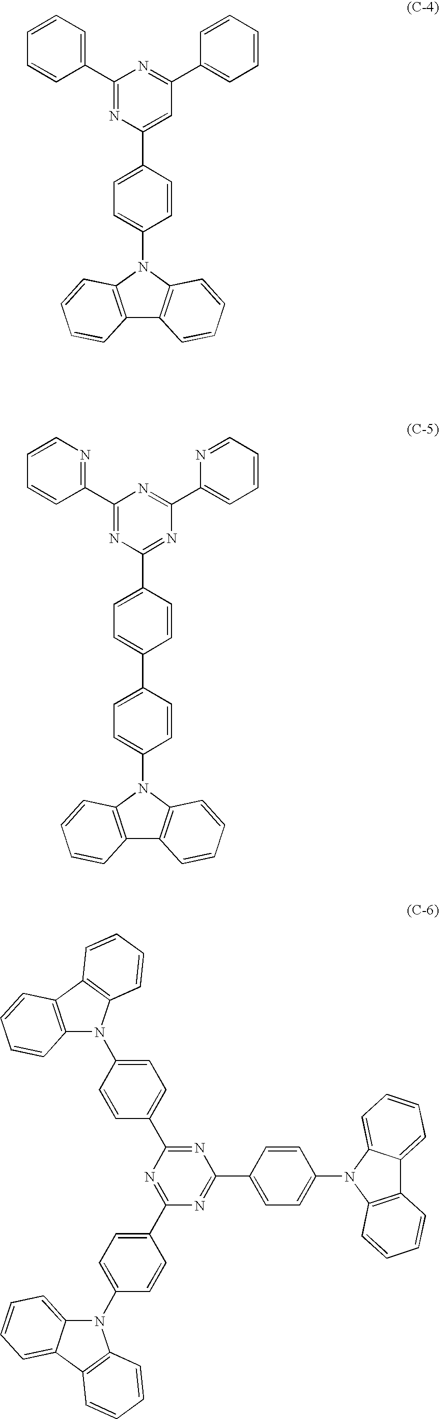 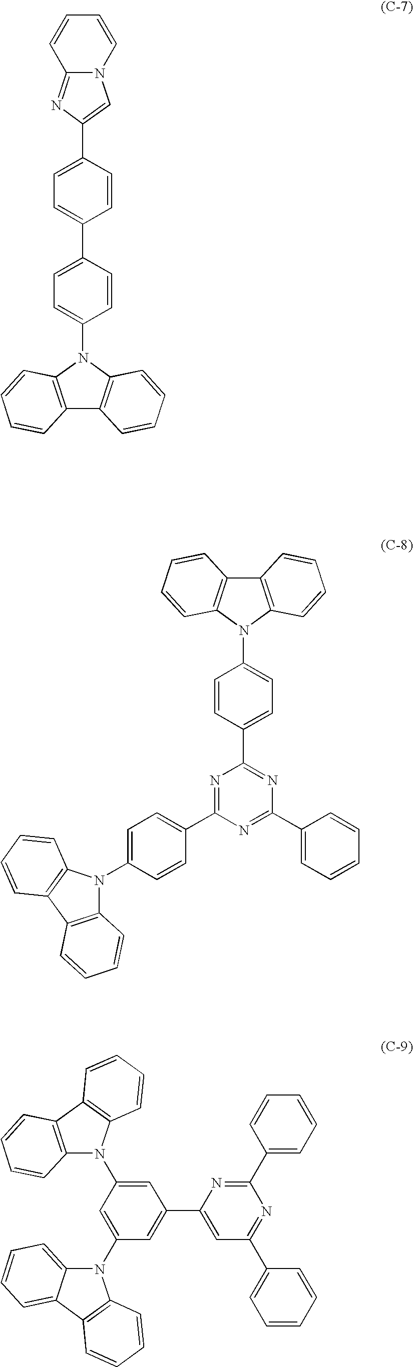 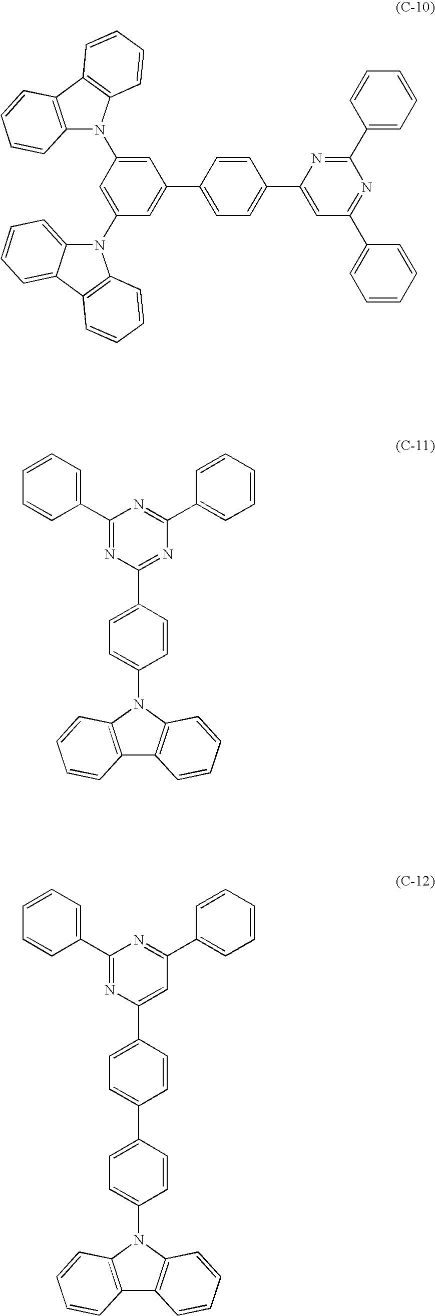 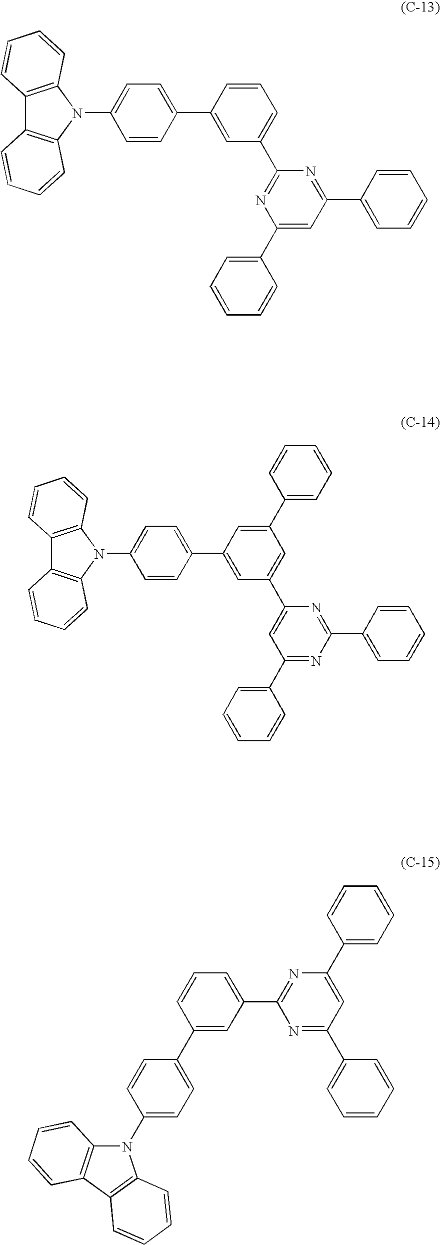 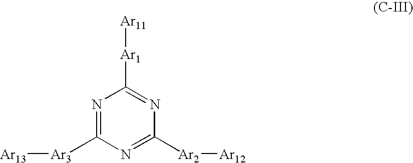
wherein Ar₁₁ to Ar₁₃ each represents the same group as R^{B2} in the general formula (B-I), specific examples are also the same as those of R^{B2}; Ar₁ to Ar₃ represents a divalent group of the same group as R^{B2} in the general formula (B-I), specific examples being the same.

Specific examples of the structure represented by the general formula (C-III) include the structures shown in the following; however, they are not limited to the following. 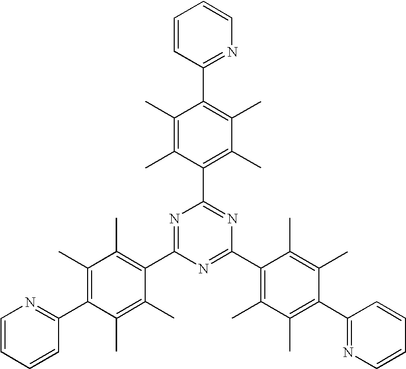 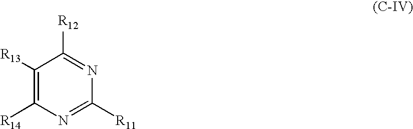
wherein R₁₁ to R₁₄ each represents the same group as R^{B2} in the general formula (B-I), specific examples are also the same as those of R^{B2}.

Specific examples of the structure represented by the general formula (C-IV) include the structures shown in the following; however, they are not limited to the following. 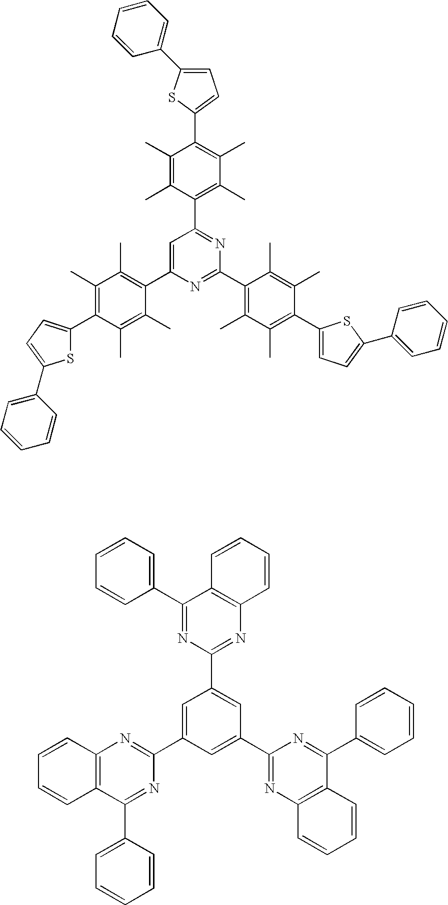 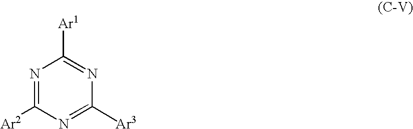
wherein Ar¹ to Ar³ each represents the same group as R^{B2} in the general formula (B-I), specific examples are also same as those of R^{B2}.

Specific examples of the structure represented by the general formula (C-V) include the structures shown in the following; however, they are not limited to the following. 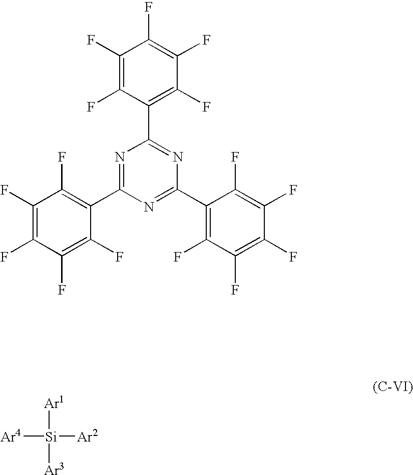
wherein Ar¹ to Ar⁴ each represents the same group as R^{B2} in the general formula (B-I), specific examples are also the same as those of R^{B2}.

Specific examples of the structure represented by the general formula (C-VI) include the structures shown in the following; however, they are not limited to the following.

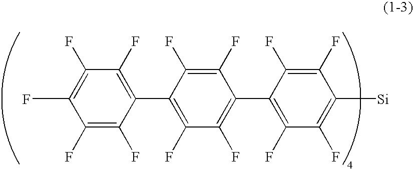

Further in the organic EL device of the present invention, it is preferable to employ an inorganic compound such as an insulating material or a semiconductor for an electron injecting or transporting layer. The electron injecting or transporting layer employing an insulating material or a semiconductor effectively prevents leak in the electric current and improves the electron injecting capability. It is preferable that at least one metal compound selected from the group consisting of alkali metal chalcogenides, alkaline earth metal chalcogenides, alkali metal halides and alkaline earth metal halides is used as the insulating material. It is preferable that the electron injecting or transporting layer is constituted with the above alkali metal chalcogenide since the electron injecting property can be improved. Preferable examples of the alkali metal chalcogenide include Li₂O, LiO, Na₂S and Na₂Se. Preferable examples of the alkaline earth metal chalcogenide include CaO, BaO, SrO, BeO, BaS and CaSe. Preferable examples of the alkali metal halide include LiF, NaF, KF, LiCl, KCl and NaCl. Preferable examples of the alkaline earth metal halide include fluorides such as CaF₂, BaF₂, SrF₂, MgF₂ and BeF₂ and halides other than the fluorides.

Examples of the semiconductor constituting the electron injecting or transporting layer include oxides, nitrides and nitriding oxides containing at least one element selected from Ba, Ca, Sr, Yb, Al, Ga, In, Li, Na, Cd, Mg, Si, Ta, Sb and Zn, which are used singly or in combination of two or more. It is preferable that the inorganic compound constituting the electron transporting layer is in the form of a fine crystalline or amorphous insulating thin film. When the electron transporting layer is constituted with the above insulating thin film, a more uniform thin film can be formed and defective pixels such as dark spots can be decreased. Examples of the inorganic compound include the alkali metal chalcogenides, the alkaline earth metal chalcogenides, the alkali metal halides and the alkaline earth metal halides which are described above.

In the present invention, a reductive dopant with a work function of 2.9 eV or smaller may be added in the electron injecting or transporting layer. The reductive dopant used in the present invention is defined as a substance which reduces the electron transporting compound.

In the present invention, it is preferable that the reductive dopant is added in the interfacial zone between the cathode and the organic thin film layer of the organic EL device, and the reductive dopant reduces at least a part of the organic layer resultantly making it anion. Examples of the reductive dopant include at least one compound selected from alkali metals, alkali metal-complexes, alkali metal compounds, alkaline earth metals, alkaline earth metal-complexes, alkaline earth metal compounds, rare earth metals, rare earth metal-complexes and rare earth metal compounds. Examples of the preferable reductive dopant include at least one alkali metal selected from a group consisting of Li (the work function: 2.93 eV), Na (the work function: 2.36 eV), K (the work function: 2.28 eV), Rb (the work function: 2.16 eV) and Cs (the work function: 1.95 eV) or at least one alkaline earth metals selected from a group consisting of Ca (the work function: 2.9 eV), Sr (the work function: 2.0 to 2.5 eV) and Ba (the work function: 2.52 eV); whose work function of 2.9 eV is particularly preferable. Among those, more preferable reductive dopants include at least one kind selected from the group consisting of K, Rb and Cs, the latter Rb or Cs being farther more preferable and the last Cs being the most preferable. Those alkaline metals have particularly high reducing capability, and only an addition of relatively small amount of them into an electron injection zone enables to expect both improvement of luminance and lifetime extension of the organic EL device.

Examples of the alkaline earth metal compound described above include BaO, SrO, CaO and mixtures thereof such as BaₓSr₁₋ₓO (0<x<1) and BaₓCa₁₋ₓO (0<x<1). Examples of the alkali oxide or alkali fluoride include LiF, Li₂O, Na F, etc. The alkali metal-complex, the alkaline earth metal-complex and the rare earth metal-complex are not particularly limited as long as the complexes contain at least one of the alkali metal ions, the alkaline earth metal ions and rare earth metal ions, respectively, as the metal ion. As the ligand, quinolinol, benzoquinolinol, acridinol, phenanthridinol, hydroxyphenyloxazole, hydroxyphenylthiazole, hydroxydiaryloxadiazoles, hydroxydiarylthiadiazoles, hydroxyphenylpyridine, hydroxyphenyl-benzimidazole, hydroxybenzotriazole, hydroxyfulvorane, bipyridyl, phenanthroline, phthalocyanine, porphyrin, cyclopentadiene, β-diketones, azomethines and derivatives of these compounds are preferable. However, the ligand is not limited to the ligands described above.

As for the addition form of the reductive dopant, it is preferable that the reductive dopant is added in a manner such that a layer or islands are formed in the interfacial zone described above. In the case where the layer of the reductive dopant is formed, a preferable film thickness is from 0.05 to 8 nm.

As the process for adding the reductive dopant, it is preferable that an organic material which is the light emitting material or the electron injecting material forming the interfacial region is vaporized while the reductive dopant is simultaneously vapor deposited in accordance with the resistance heating deposition process so that the reductive dopant is dispersed in the organic material. The concentration of the dispersion expressed as the ratio of the amounts by mole of the organic substance to the reductive dopant is in the range of 100:1 to 1:100 and preferably in the range of 5:1 to 1:5. When the reductive dopant is added to form a layer, the reductive dopant alone is vapor deposited in accordance with the resistance heating deposition process to form a layer preferably having a thickness of 0.1 to 15 nm after a layer of the organic material such as the light emitting material and the electron injecting material is formed as the interfacial zone. When the reductive dopant is added to form islands, the reductive dopant alone is vapor deposited in accordance with the resistance heating deposition process to form islands preferably having a thickness of 0.1 to 15 nm after islands of the organic material such as the light emitting material and the electron injecting material were formed as the interfacial zone.

It is preferable that the light emitting layer in the organic EL device of the present invention has functions capable of injecting holes from the anode or the hole injecting layer when an electric field is applied, of injecting electrons from the cathode or the electron injecting layer, of mobilizing the injected electric charges (electrons and holes) by means of the electric field, and of providing a space for recombination of the electrons and holes thereby urging the light emission. It is preferable for the organic EL device of the present invention that the light emitting layer at least comprises the metal-complex compound of the present invention, and it may comprise a host material which employs the metal-complex compound as a guest material. Examples of the above host material include such as those having a carbazole skeleton, those having a diarylamine skeleton, those having a pyridine skeleton, those having a pyrazine skeleton, those having a triazine skeleton, those having an arylsilane skeleton, etc. It is preferable that T1 (energy level in the minimum triplet excitation state) of the host material is larger than T1 level of the guest material. The host material may be either a low molecular weight compound or a high molecular weight compound. Further, the light emitting layer in which the above light emitting materials are doped into thr above host materials can be formed by codeposition of the host materials and the light emitting materials such as the above metal-complex compound, etc.

In the organic EL device of the present invention, although a process for forming each layers are not particularly specified, various kinds of process such as a vacuum deposition process, a LB process, a resistance heating deposition process, an electron beam process, a sputtering process, a molecular lamination process, a coating process (a spin coating process, a cast process, a dip coating process), an ink-jet process, a printing process are employable and the coating process of applying the materials over a substrate is preferable in the present invention.

The organic thin film layer comprising the metal-complex compound of the present invention can be formed in accordance with the vacuum vapor deposition process, the molecular beam epitaxy process (the MBE process) or, using a solution prepared by dissolving the compound into a solvent, in accordance with a conventional coating process such as the dipping process, the spin coating process, the casting process, the bar coating process and the roller coating process.

In the above coating process, preparing a coating solution by dissolving the metal-complex compound of the present invention into a solvent, and by applying the coating solution over the surface of a predetermined layer (or, electrode), followed by drying may form the organic thin film layer. In the coating solution, a resin may be contained either by dissolved in a solvent or by dispersing into the solvent. Regarding with the resin, both non-conjugate high polymer (for example, polyvinylcarbazole) and conjugate high polymer (for example, polyolefin-based high polymer) are employable. Specific examples include polyvinylchloride, polycarbonate, polystyrene, polymethyl methacrylate, poly butylmethacrylate, polyester, polysulfone, polyphenylene oxide, polybutadiene, poly(N-vinyl carbazole), hydrocarbon resin, ketone resin, phenoxy resin, polyamide, ethyl cellulose, vinyl acetate, ABS resin, polyurethane, melamine resin, unsaturated polyester resin, alkyd resin, epoxide resin, silicone resin, etc.

The thickness of each layer in the organic thin film layer in the organic EL device of the present invention is not particularly limited. In general, an excessively thin layer tends to have defects such as pin holes, and an excessively thick layer requires a high applied voltage results in decreasing the efficiency. Therefore, a thickness within the range of several nanometers to 1 μm is preferable.

### EXAMPLES

The present invention will be described in more detail by reference to the following examples.

### Synthesis Example 1

### Synthesis of Compound (2)

Compound (2) was synthesized in accordance with the following route of reactions:

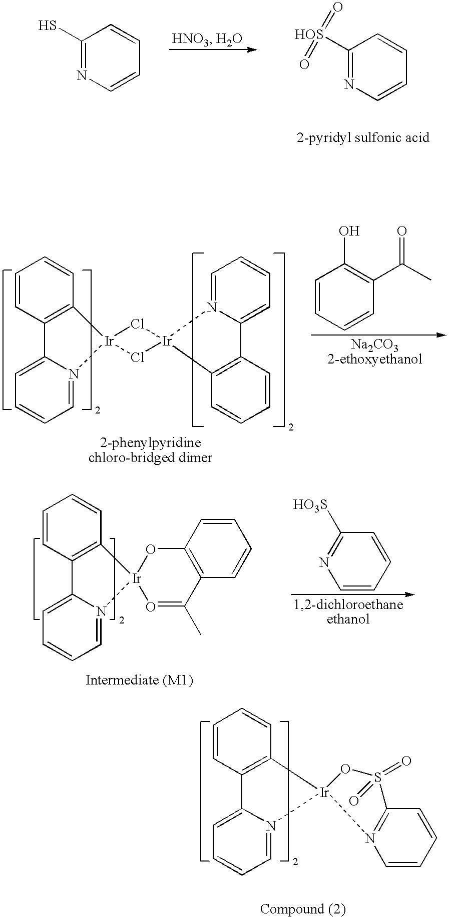

### (1) Synthesis of 2-pyridyl sulfonic acid

Diluting 40 milliliter of a concentrated nitric acid solution with 100 milliliter of distilled water, entering the resultant solution into a flask equipped with a cooling pipe and having a capacity of 500 milliliter and adding 2-mercaptopyridine in an amount of 6 g while stirring, the resultant mixture was dissolved. The resultant solution was slowly heated and further stirred at a temperature of 85° C. for 9 hours. Then, the nitric acid was distilled and a resultant residue in an amount of 15 g was re-crystallized from water and methanol. Separating a precipitated needle crystal by filtration, and after washing it with the use of methanol, it was dried at a temperature of 60° C. for 2 hours and as a result, 7.0 g of crystal was obtained. Further, re-crystallizing operation from water and methanol was conducted again, and 4.1 g of 2-pyridyl sulfonic acid (white needle crystal) was obtained. A structure of the white needle crystal was recognized by means of GC-mass spectrum.

GC-MS: calcd for C₅H₅NO₃S=159, found, m/z=159 (100)

### (2) Synthesis of Intermediate (M1)

Placing 2-phenylpyridinechloro-bridged dimer[tetrakis(2-phenyl pyridine-C²,N′)(μ-dichloro)diiridium] obtained in accordance with a process described in a publicly known document: Sprouse et al., J. Am. Chem. Soc., 106, 6647 (1984), in an amount of 7.0 g (6.5 mmol), 2′-hydroxyacetophenone in an amount of 2.2 g, sodium carbonate in an amount of 8.3 g and 2-ethoxyethanol in an amount of 90 milliliter into a three neck flask having a capacity of 300 milliliter, the atmosphere was replaced with argon gas, and the resultant solution was refluxed under heating while stirring for 11 hours. The temperature was returned to room temperature, a precipitate was separated by filtration, and after washing the precipitate with the use of water and ethanol, it was dried at a temperature of 60° C. for 6 hours and as a result, 11 g of orange solid (M1) was obtained.

### (3) Synthesis of Compound (2)

Placing Intermediate (M1) in an amount of 2.6 g (4.1 mmol), 2-pyridylsulfonic acid in an amount of 650 mg (4.1 mmol) into a eggplant type flask having a capacity of 200 milliliter, adding 1,2-dichloroethane in an amount of 120 milliliter and ethanol in an amount of 30 milliliter, the resultant solution was refluxed under heating for 3 hours while stirring with an equipment of a cooling pipe onto the flask. After cooling the resultant solution down to a room temperature, a solid was separated by filtration and then, concentrating a filtrate, it was refined with 75 g-silicagel column chromatography and as a result, 1.2 g of a yellow solid was obtained. Further, carrying out sublimation purification, 0.8 g of Compound (2) was obtained. A structure of the yellow solid was recognized by means of Field Desorption Mass Spectrum (FD-MS). A measurement result of FD-MS is shown as the followings:

FD-MS: calcd for IrC₂₇H₂₀N₃O₃S=659, found, m/z=659 (100)

### Synthesis Example 2

### Synthesis of Compound (12)

Compound (12) was synthesized in accordance with the following route of reactions: 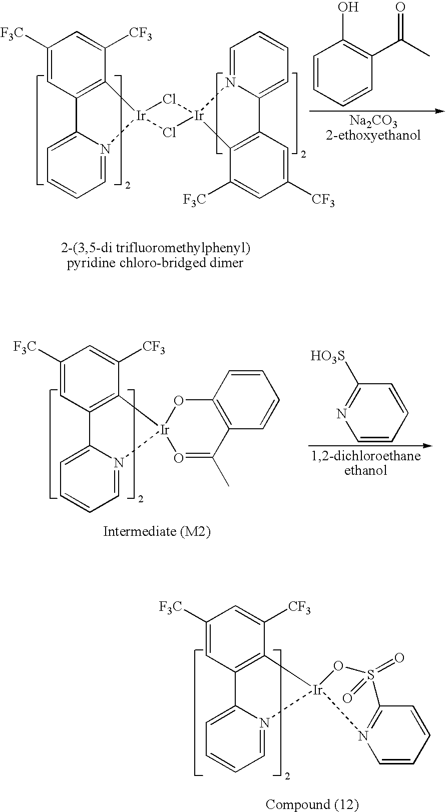
(1) Synthesis of Intermediate (M2)

Placing 2-(3,5-di trifluoromethylphenyl)pyridine chloro-bridged dimer in an amount of 5.2 g (3.2 mmol) prepared in a similar manner as the step (2) of the above Synthesis Example 1 and described in the publicly known document, 2′-hydroxyacetophenone in an amount of 1.1 g, sodium carbonate in an amount of 7.0 g and 2-ethoxyethanol in an amount of 80 milliliter into a three neck flask having a capacity of 300 milliliter, replacing the atmosphere with argon gas, the resultant solution was refluxed under heating for 10 hours while stirring. The temperature was returned to room temperature, a precipitate was separated by filtration, and after washing the precipitate with the use of water and ethanol, it was dried at a temperature of 60° C. for 6 hours and as a result, 4.8 g of orange solid (M2) was obtained.

(2) Synthesis of Compound (12)

Placing Intermediate (M2) in an amount of 3.5 g (3.8 mmol), 2-pyridylsulfonic acid in an amount of 600 mg (3.8 mmol) into an eggplant type flask having a capacity of 200 milliliter, adding 1,2-dichloroethane in an amount of 100 milliliter and ethanol in an amount of 25 milliliter, the resultant solution was refluxed under heating for 5 hours while stirring with an equipment of a cooling pipe onto the flask. After cooling the resultant solution down to a room temperature, a solid was separated by filtration and then, concentrating a filtrate, it was refined with 75 g-silicagel column chromatography and as a result, 1.5 g of a pale yellow solid was obtained. Further, carrying out sublimation purification, 1.1 g of Compound (12) was obtained. A structure of the yellow solid was recognized by means of FD-MS. A measurement result of FD-MS is shown as the followings:

FD-MS: calcd for IrC₃₁H₁₆F₁₂N₃O₃S=931, found, m/z=931 (100)

### Synthesis Example 3

### Synthesis of Compound (5)

Compound (5) below was synthesized in accordance with the following route of reactions: 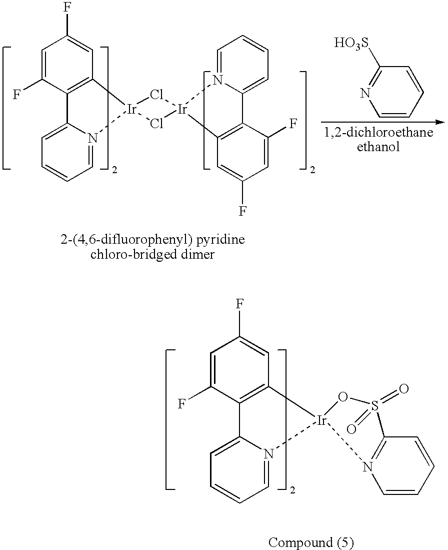
(1) Synthesis of Compound (5)

Placing 2-(4,6-difluorophenyl) pyridine chloro-bridged dimer in an amount of 6.0 g (4.9 mmol), 2-pyridylsulfonic acid in an amount of 950 mg (6.0 mmol) into an eggplant type flask having a capacity of 200 milliliter, adding 1,2-dichloroethane in an amount of 120 milliliter and ethanol in an amount of 30 milliliter, the resultant solution was refluxed under heating for 6 hours while stirring with an equipment of a cooling pipe onto the flask. After cooling the resultant solution down to a room temperature, a solid was separated by filtration and then, concentrating a filtrate, it was refined with 80 g-silicagel column chromatography and as a result, 2.6 g of an pale yellow solid was obtained. Further, carrying out sublimation purification, 1.8 g of Compound (5) was obtained. A structure of the yellow solid was recognized by means of FD-MS.

FD-MS: calcd for IrC₂₇H₁₆F₄N₃O₃S=731, found, m/z=731 (100)

### Synthesis Example 4

### Synthesis of Compound (48)

Compound (48) below was synthesized in accordance with the following route of reactions:

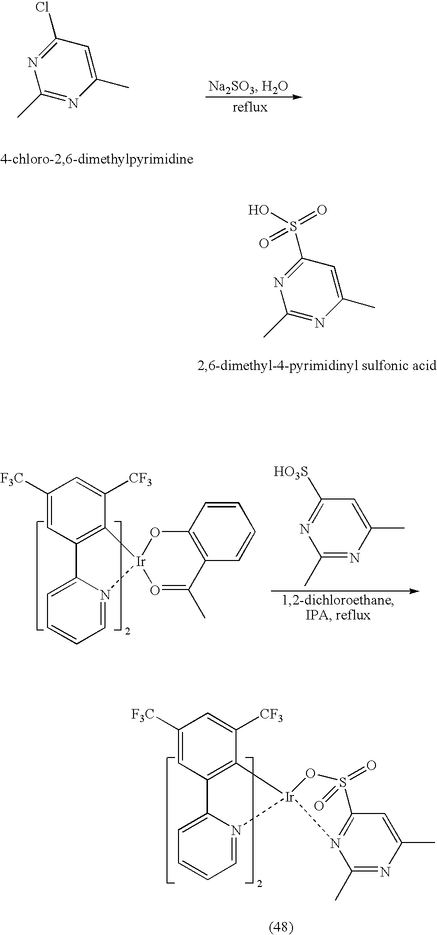

### (1) Synthesis of 2,6-dimethyl-4-pyrimidinyl sulfonic acid

Placing 4-chloro-2,6-dimethylpyrimidine in an amount of 2.6 g, sodium sulfite in an amount of 7 g and water in an amount of 20 milliliter into a three neck flask equipped with a cooling pipe and having a capacity of 300 milliliter, the resultant mixture was dissolved while stirring. The resultant solution was slowly heated and further stirred for 2 hours. Then, adjusting the pH to a value of 6 with the use of dilute hydrochloric acid, a mixture was extracted with diethyl ether. After drying the mixture with the use of sulfuric magnesium anhydride, the dried mixture was separated by filtration and concentrated and as a result, 1.8 g of white crystal was obtained. A structure of the white crystal was recognized by means of GC-mass spectrum.

GC-MS: calcd for C₆H₈N₂O₃S=188, found, m/z=188 (100)

### (2) Synthesis of Compound (48)

Placing Intermediate (M2) in an amount of 3.0 g (3.2 mmol), 2,6-dimethyl-4-pyrimidinyl sulfonic acid in an amount of 620 mg (3.3 mmol) into an eggplant type flask having a capacity of 200 milliliter, adding 1,2-dichloroethane in an amount of 100 milliliter and isopropanol in an amount of 25 milliliter, the resultant solution was refluxed under heating for 28 hours while stirring with an equipment of a cooling pipe onto the flask. After cooling the resultant solution down to a room temperature, a solid was separated by filtration and then, concentrating a filtrate, it was refined with 60 g-silicagel column chromatography and as a result, 800 m g of a pale yellow solid was obtained. Further, carrying out sublimation purification, 520 mg of Compound (48) was obtained. A structure of the pale yellow solid was recognized by means of FD-MS. A measurement result of FD-MS is shown as the followings:

FD-MS: calcd for IrC₃₁H₁₇F₁₂N₄O₃S=946, found, m/z=946 (100)

### Synthesis Example 5

### Synthesis of Compound (27)

Compound (27) below was synthesized in accordance with the following route of reactions:

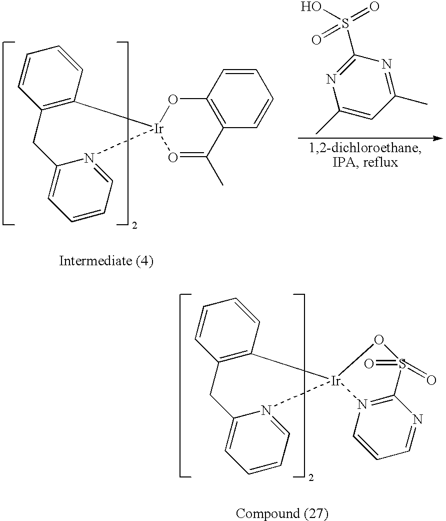

Intermediate (4) was synthesized in a similar manner as Intermediate (M3) in Synthesis Example (3) by reacting chloro-bridged dimer as material with hydroxyacetophenone. Further, 4,6-dimethyl-2-pyrimidinyl sulfonic acid was synthesized in a similar manner as Synthesis Example (4) employing 2-chloro-4,6-dimethylpyrimidine as material and sodium nitrite. Placing Intermediate (4) in an amount of 2.3 g (3.4 mmol) and 4,6-dimethyl-2-pyrimidinyl sulfonic acid in an amount of 680 milliliter into an eggplant type flask having a capacity of 200 milliliter, adding 1,2-dichloroethane in an amount of 100 milliliter and isopropanol in an amount of 20 milliliter, the resultant solution was refluxed under heating for 24 hours. After cooling the resultant solution down to a room temperature, a solid was separated by filtration and then, concentrating a filtrate, it was refined with 50 g-silicagel column chromatography and as a result, 840 mg of an yellow solid was obtained. Further, carrying out sublimation purification, 670 g of Compound (27) was obtained. A structure of the yellow solid was recognized by means of FD-MS. A measurement result of FD-MS is shown as the followings:

FD-MS: calcd for IrC₂₈H₂₃N₄O₃S=688, found, m/z=688 (100)

### Example 1

A glass substrate of 25 mm×75 mm×1.1 mm thickness having an ITO transparent electrode was cleaned by application of ultrasonic wave in isopropyl alcohol for 5 minutes and then by exposure to ozone generated by ultraviolet light for 30 minutes. The glass substrate having the transparent electrode which had been cleaned was attached to a substrate holder of a vacuum vapor deposition apparatus. On the surface of the cleaned substrate at the side having the transparent electrode, a film of TPD232 having a thickness of 100 nm was formed so that the formed film covered the transparent electrode. The formed film of TPD232 worked as the hole injecting layer. Further on the formed film, 4,4′,4″-tris(carbazole-9-yl)-triphenylamine (TCTA) below was film-formed obtaining a film thickness of 10 nm. The formed film of TCTA worked as the hole transporting layer. On the formed film of TCTA, a film having a thickness of 30 nm of Compound (A) below as a host material was vapor deposited to form a light emitting layer. Simultaneously, the above metal-complex Compound (5) was added as a phosphorus photoluminescent Ir metal-complex dopant. A concentration of metal-complex Compound (5) in the light emitting layer was 7.5% by weight. The formed film worked as a light emitting layer. On the film formed above, a film of Alq having a thickness of 30 nm was formed. The formed film of BAlq worked as an electron transporting layer. Subsequently, lithium fluoride was deposited up to 0.1 nm in thickness and then, aluminum was deposited up to 150 nm in thickness. The Al/LiF worked as a cathode. An organic EL device was fabricated in the manner described above.

The device fabricated above was sealed and examined by feeding electric current. Bluish green light was emitted with a luminance of 100 cd/m² under a voltage of 7.9 V and a current density of 0.47 mA/cm². The current efficiency was 21.3 cd/A. Further, as a result of subjecting the device to a continuous test by feeding a constant electric current starting at an initial luminance of 200 cd/m², it was confirmed that the half lifetime that the luminance reduced to the half value: 100 cd/m² was 750 hours.

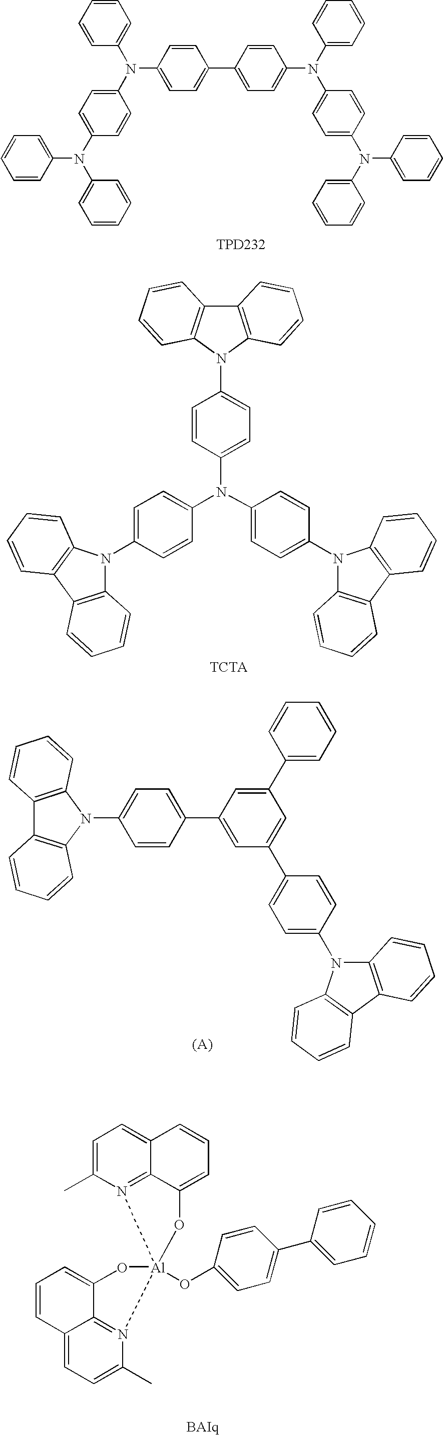

### Examples 2 to 5

Organic EL devices were prepared in similar manners as Example 1 except that compounds described in Table 1 were employed instead of Compound (5). The devices fabricated above were sealed and examined by feeding electric current in the same manner as Example 1, and the results are shown in Table 1.

### Comparative Examples 1 to 5

Organic EL devices were fabricated in the same manner as Example 1 except that Compound FIracac below (Comparative Example 1), Compound FIrpic below (Comparative Example 2), Compound (B) below (Comparative Example 3), Compound (C) below (Comparative Example 4) and Compound (D) below (Comparative Example 5) were employed instead of Compound (5) in Example 1 each as the metal-complex compound respectively.

The devices fabricated above were sealed and examined by feeding electric current in the same manner as Example 1, and the results are shown in Table 1.

TABLE 1

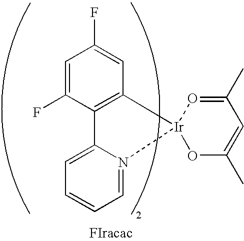

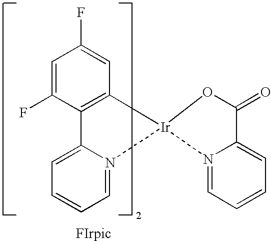

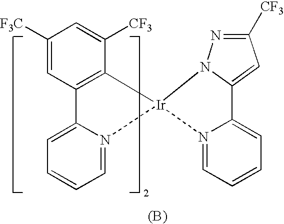

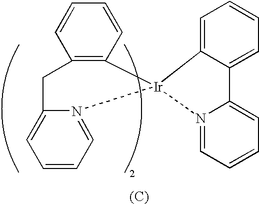

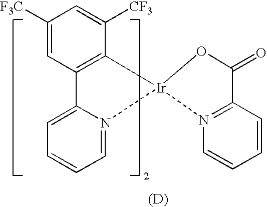

| | Dopant in | | | | | | |
|---|---|---|---|---|---|---|---|
| | Light | | Current | | Current | Color of | Half |
| | emitting | Voltage | Density | Luminance | Efficiency | Light | Lifetime |
| | layer | (V) | (mA/cm²) | (cd/m²) | (cd/A) | emission | (hours) |
| Example 1 | (5) | 7.9 | 0.47 | 100 | 21.3 | Bluish green | 750 |
| Example 2 | (12) | 7.6 | 0.53 | 105 | 19.8 | Bluish green | 1220 |
| Example 3 | (48) | 7.4 | 0.44 | 101 | 23.0 | Bluish green | 992 |
| Example 4 | (2) | 7.6 | 0.46 | 100 | 21.7 | Green | 885 |
| Example 5 | (27) | 7.5 | 0.66 | 108 | 16.4 | Bluish green | 682 |
| Comparative | FIracac | 8.0 | 0.84 | 102 | 12.1 | Bluish green | 228 |
| Example 1 | | | | | | | |
| Comparative | FIrpic | 7.6 | 0.73 | 101 | 13.8 | Bluish green | 24 |
| Example 2 | | | | | | | |
| Comparative | (B) | 7.4 | 0.75 | 99 | 13.2 | Bluish green | 5 |
| Example 3 | | | | | | | |
| Comparative | (C) | 7.9 | 0.88 | 103 | 11.7 | Green | 134 |
| Example 4 | | | | | | | |
| Comparative | (D) | 7.6 | 0.82 | 106 | 12.9 | Bluish green | 305 |
| Example 5 | | | | | | | |

As shown in Table 1, it is verified that the organic EL devices of Examples 1 to 5 employing of the metal-complex compound of the present invention exhibit enhanced current efficiencies and prolonged lifetimes relative to Comparative Examples 1 to 5.

### Example 6

Organic EL device was fabricated in a similar manner as Example 1 except that providing an electron transport-assisting layer with a thickness of 25 nm of Compound (E) below at the light emitting layer side instead of BAlq film when forming the electron transporting layer, and except that forming the electron injection layer with film thickness of 5 nm employing Alq below.

The devices fabricated above were sealed and examined by feeding electric current in the same manner as Example 1, and the results are shown in Table 2.

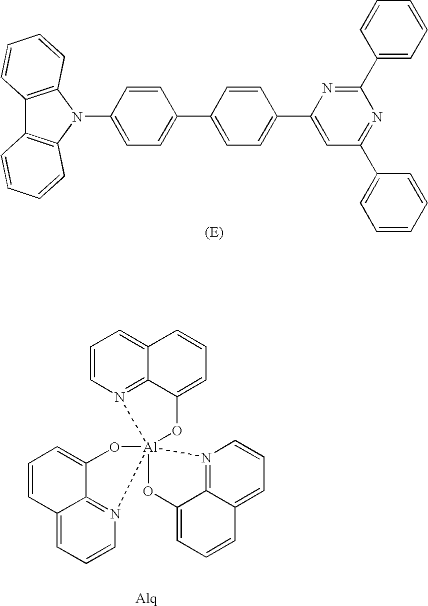

### Examples 7 to 8

Organic EL devices were fabricated in similar manners as Example 1 except that compounds described in Table 1 were employed instead of Compound (5) in Example 1 each as the metal-complex compound respectively.

The devices fabricated above were sealed and examined by feeding electric current in the same manner as Example 1, and the results are shown in Table 2.

### Comparative Examples 6 to 9

Organic EL devices were fabricated in the same manner as Example 1 except that Compound FIracac below (Comparative Example 6), Compound FIrpic below (Comparative Example 7), Compound (B) below (Comparative Example 8) and Compound (C) below (Comparative Example 9) were employed instead of Compound (5) in Example 1 each as the metal-complex compound respectively.

The devices fabricated above were sealed and examined by feeding electric current in the same manner as Example 1, and the results are shown in Table 2.

TABLE 2

| | Dopant in | | | | | | |
|---|---|---|---|---|---|---|---|
| | Light | | Current | | Current | Color of | |
| | emitting | Voltage | Density | Luminance | Efficiency | Light | Half Lifetime |
| | layer | (V) | (mA/cm²) | (cd/m²) | (cd/A) | emission | (hours) |
| Example 6 | (5) | 7.1 | 0.38 | 108 | 28.6 | Bluish green | 933 |
| Example 7 | (12) | 6.8 | 0.32 | 98 | 30.6 | Bluish green | 1422 |
| Example 8 | (48) | 6.8 | 0.35 | 102 | 29.1 | Bluish green | 918 |
| Comparative | FIracac | 7.3 | 0.61 | 100 | 16.3 | Bluish Green | 230 |
| Example 6 | | | | | | | |
| Comparative | FIrpic | 7.0 | 0.54 | 99 | 18.3 | Bluish green | 32 |
| Example 7 | | | | | | | |
| Comparative | (B) | 7.1 | 0.51 | 100 | 19.6 | Bluish green | 5 |
| Example 8 | | | | | | | |
| Comparative | (D) | 7.1 | 0.50 | 104 | 20.8 | Bluish green | 348 |
| Example 9 | | | | | | | |

As shown in Table 2, it is verified that the organic EL devices of Examples 6 to 8 employing the metal-complex compound of the present invention exhibit enhanced current efficiencies and prolonged lifetimes relative to Comparative Examples 6 to 9.

### INDUSTRIAL APPLICABILITY

As described above in detail, the organic EL device employing the novel metal-complex compound of the present invention emits various phosphorous light including blue light having an enhanced current efficiency and prolonged lifetime. Accordingly, the present invention is applicable for a field such as various display devices, display panels, backlights, illuminating light sources, beacon lights, signboards, and interior designs, particularly suitable as display device for color displays.

What is claimed is:

1. A metal-complex compound represented by a following general formula (I):
(L₁)ₘM(L₂)ₙ (1)
wherein M represents a metal atom of iridium (Ir), platina (Pt), rhodium (Rh), ruthenium (Ru) or palladium (Pd);
L₁ and L₂ each independently represent a bidentate ligand that is different from each other;
a partial structure (L₁)ₘM is expressed by a following general formula (2);
a partial structure M(L₂)ₙ is expressed by a following general formula (3);
m and n each independently represents an integer of 1 or 2, while m plus n makes an integer of 2 or 3; 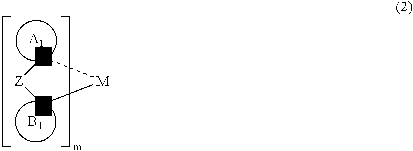
wherein N and C each respectively corresponds to a nitrogen atom and a carbon atom in this order; A1 ring corresponds to an aromatic heterocyclic group containing a nitrogen atom and having 3 to 50 nuclear carbon atoms which may have a substituent; B1 ring corresponds to an aryl group having 6 to 50 nuclear carbon atoms which may have a substituent;
while A1 ring and B1 ring bonds each other with a covalent bond that shares Z;
Z represents a single bond, —O—, —S—, —CO—, —(CR′R″)ₙ—, —(SiR′R″)ₐ— or —NR′—;
R′ and R″ each independently represents a hydrogen atom, an aryl group having 6 to 50 nuclear carbon atoms which may have a substituent, an aromatic heterocyclic group having 3 to 50 nuclear atoms which may have a substituent, or an alkyl group having 1 to 50 carbon atoms which may have a substituent; a represents an integer of 1 to 10; while R′s and R″s may be the same with or different from each other; 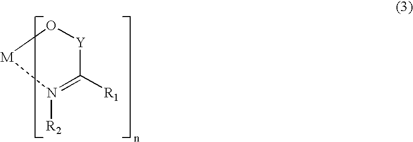
wherein N and O each respectively corresponds to a nitrogen atom and an oxygen atom in this order;
R₁ and R₂ each independently represents an alkyl group having 1 to 50 carbon atoms which may have a substituent, an alkenyl group having 2 to 50 carbon atoms which may have a substituent, or an aryl group having 6 to 50 nuclear carbon atoms which may have a substituent; while R₁ and R₂ may bond each other to form a ring structure;
Y represents any one of following groups: 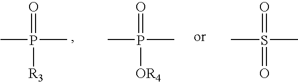
wherein P and S each corresponds to a phosphorus atom and a sulfur atom in this order; R₃ and R₄ each independently represents an alkyl group having 1 to 50 carbon atoms which may have a substituent, or an aryl group having 6 to 50 nuclear carbon atoms which may have a substituent.

2. The metal-complex compound according to claim 1, wherein the partial structure (L₁)ₘM expressed by the general formula (2) is represented by a following general formula (4) or a following general formula (5): 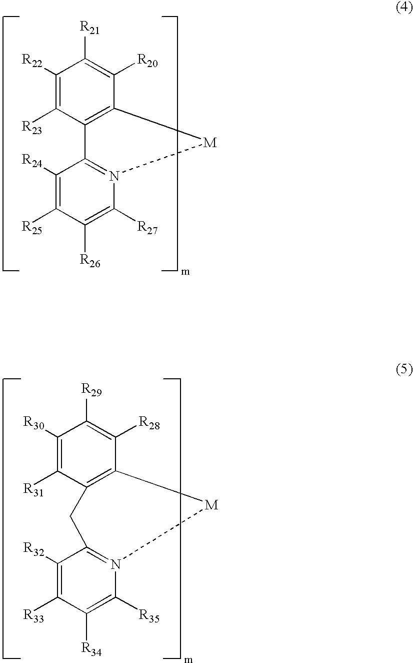
wherein M and m are the same as the above description;
R₂₀ to R₃₅ each independently represents a hydrogen atom, an alkyl group having 1 to 30 carbon atoms which may have a substituent, an alkyl halide group having 1 to 30 carbon atoms which may have a substituent, an alkoxy group having 1 to 30 carbon atoms which may have a substituent, a heterocyclic group having 3 to 20 nuclear carbon atoms which may have a substituent, an aryl group having 6 to 40 nuclear carbon atoms which may have a substituent, an aryloxy group having 6 to 40 nuclear carbon atoms which may have a substituent, an aralkyl group having 7 to 40 carbon atoms which may have a substituent, an alkenyl group having 2 to 30 carbon atoms which may have a substituent, an arylamino group having 6 to 80 nuclear carbon atoms which may have a substituent, an alkylamino group having 1 to 60 carbon atoms which may have a substituent, an aralkyl amino group having 7 to 80 carbon atoms which may have a substituent, an alkylsilyl group having 1 to 30 carbon atoms which may have a substituent, an arylsilyl group having 6 to 40 carbon atoms which may have a substituent, a halogen atom, a cyano group, a nitro group, —S(R)O₂ or —S(R)O, wherein R represents a substituent; and
wherein each adjacent couple among R₂₀ to R₂₇ and R₂₈ to R₃₅ may bond each other to form a ring structure.

3. The metal-complex compound according to claim 1, wherein the partial structure M(L₂)ₙ expressed by the general formula (3) is represented by any one of following general formulae (6) to (10): 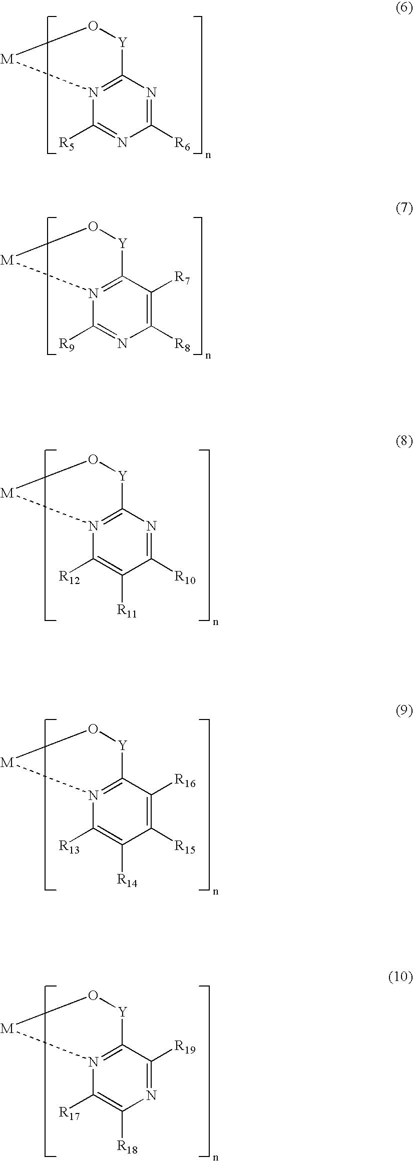
wherein M, Y and n are the same as the above description;
R₅ to R₁₉ each independently represents a hydrogen atom, an alkyl group having 1 to 30 carbon atoms which may have a substituent, an alkyl halide group having 1 to 30 carbon atoms which may have a substituent, an alkoxy group having 1 to 30 carbon atoms which may have a substituent, a heterocyclic group having 3 to 20 nuclear carbon atoms which may have a substituent, an aryl group having 6 to 40 nuclear carbon atoms which may have a substituent, an aryloxy group having 6 to 40 nuclear carbon atoms which may have a substituent, an aralkyl group having 7 to 40 carbon atoms which may have a substituent, an alkenyl group having 2 to 30 carbon atoms which may have a substituent, an arylamino group having 6 to 80 nuclear carbon atoms which may have a substituent, an alkylamino group having 1 to 60 carbon atoms which may have a substituent, an aralkyl amino group having 7 to 80 carbon atoms which may have a substituent, an alkylsilyl group having 1 to 30 carbon atoms which may have a substituent, an arylsilyl group having 6 to 40 carbon atoms which may have a substituent, a halogen atom, a cyano group, a nitro group, —S(R)O₂ or —S(R)O, wherein R represents a substituent; and
a couple of R₇ and R₈, a couple of R₁₀ and R₁₁, a couple of R₁₁ and R₁₂, a couple of R₁₃ and R₁₄, a couple of R₁₄ and R₁₅, a couple of R₁₅ and R₁₆, and a couple of R₁₇ and R₁₈ may bond each other to form a ring structure.

4. The metal-complex compound according to claim 1, wherein the partial structure (L₁)ₘM expressed by the general formula (2) is represented by the general formula (4) or the general formula (5); and wherein the partial structure M(L₂)ₙ expressed by the general formula (3) is represented by any one of the general formulae (6) to (10).

5. The metal-complex compound according to claim 1, wherein the partial structure (L₁)ₘM expressed by the general formula (2) is represented by the general formula (4) or the general formula (5); wherein the partial structure M(L₂)ₙ expressed by the general formula (3) is represented by any one of the general formulae (6) to (10); and wherein m is an integer of 2, n is an integer of 1, and M is an iridium atom.

6. An organic electroluminescence device which comprises at least one organic thin film layer sandwiched between a pair of electrodes consisting of an anode and a cathode, wherein the organic thin film layer comprises the metal-complex compound according to any one of claims 1 to 5.

7. The organic electroluminescence device according to claim 6, wherein said light emitting layer comprises said metal-complex compound.

8. The organic electroluminescence device according to claim 6, wherein said light emitting layer comprises said metal-complex compound as a dopant.

9. The organic electroluminescence device according to claim 6, wherein at least one of an electron injecting layer or an electron transporting layer is sandwiched between said light emitting layer and said cathode; and wherein said at least one of an electron injecting layer or an electron transporting layer comprises a π-electron lacking heterocyclic derivative having a nitrogen atom as an essential component.

10. The organic electroluminescence device according to claim 6, wherein a reductive dopant is added into an interfacial region between said cathode and said organic thin film layer.
